(19) United States
(12) Patent Application Publication
(10) Pub. No.: US 2024/0310746 A1
(43) Pub. Date: Sep. 19, 2024

(54) TONER, DEVELOPER, TONER STORAGE CONTAINER, IMAGE FORMING APPARATUS, IMAGE FORMING METHOD

(71) Applicants: Daisuke INOUE, Shizuoka (JP); Keiji MAKABE, Shizuoka (JP); Tsukiko TAKAHASHI, Shizuoka (JP); Taishi YAMASHITA, Shizuoka (JP); Shuto SUNAGA, Shizuoka (JP)

(72) Inventors: Daisuke INOUE, Shizuoka (JP); Keiji MAKABE, Shizuoka (JP); Tsukiko TAKAHASHI, Shizuoka (JP); Taishi YAMASHITA, Shizuoka (JP); Shuto SUNAGA, Shizuoka (JP)

(21) Appl. No.: 18/605,957

(22) Filed: Mar. 15, 2024

(30) Foreign Application Priority Data
Mar. 16, 2023 (JP) 2023-042013

(51) Int. Cl. G03G 9/087; G03G 9/08; G03G 9/09; G03G 15/08

(52) U.S. Cl. CPC G03G 9/08755; G03G 9/0819; G03G 9/08782; G03G 9/09; G03G 15/08

(57) ABSTRACT

Toner may comprise toner particles that comprise a binder resin; the toner particles have a volume average particle diameter from 4.0 μm to 6.0 μm, and the toner has a number content of coarse particle of 20 μm or more from 10 to 250 in 10 mg of the toner.

### CROSS-REFERENCE TO RELATED APPLICATION

The present application claims priority under 35 U.S.C. § 119 to Japanese Patent Application No. 2023-042013, filed Mar. 16, 2023, the contents of which are incorporated herein by reference in their entirety.

### BACKGROUND OF THE DISCLOSURE

The present disclosure relates to a toner, a developer, a toner storage container, an image forming apparatus, and an image forming method.

The toner is required to improve the quality of the output image. Traditionally, toner made by a kneading and milling method has been used. However, since the toner manufactured by the kneading and milling method is difficult to reduce the particle size and its shape is irregular and its particle size distribution is broad. Thus, the output image quality is insufficient, and the fixing energy is high.

Therefore, in order to overcome the problem of the kneading and milling method, a method for manufacturing toner by polymerization has been proposed (see JP2022103861A, JP2016139064A, JP2014164186A, and JP201319049). The toner manufactured by the polymerization process is easily reduced in particle size, and the volume average particle size distribution is smaller than that of the toner manufactured by the kneading and milling method, and it is possible to manufacture the toner that is sharp and nearly spherical. Compared with the toner made by the kneading and milling method, these toners are of higher quality and less prone to abnormal image.

In recent years, there has been a need for a method of manufacturing toner that has a smaller particle size and is difficult to produce abnormal images (see JP2006126360A). Black spots become a problem as abnormal images. This is caused by coarse particles that deviate from the volume average particle size. Coarse particles are not transcribed successfully, and the area around them becomes thickened, producing black spots. Even by the polymerization process, coarse particles outside the volume average particle size exist, and the process to remove them is required. If the above-mentioned process conditions are tightened, the quality will be improved, but this will result in more loss. There are many references that specify coarse particles of 25 μm or more. However, for further improvement of image quality, it is necessary to focus on finer coarse particles. In addition, from the viewpoint of image quality and resolution, smaller volume average particle diameter Dv of toner has more advantage and should be 6.0 μm or less. When the volume average particle size is large, abnormal images such as black spots are easily generated.

Meanwhile, the image forming apparatus performs a charging step of uniformly charging an image forming area on the surface of the electrostatic latent image bearer, an exposure step of writing on the electrostatic latent image bearer, a developing step of forming an image by a toner that is triboelectric charged onto the electrostatic latent image bearer, and a transfer step of transferring an image on the electrostatic latent image bearer directly or indirectly via the intermediate transfer member, and then fixes the image on the printing paper. The residual transfer toner remaining on the electrostatic latent image carrier is removed from the electrostatic latent image bearer by the cleaning step and starts the next image forming process.

As the cleaning member of the cleaning means, it is well known that the cleaning blade having the shape of a rectangular strip is used, which allows for simpler apparatus configuration and better cleaning performance. Specifically, the proximal end of the cleaning blade is supported by a supporting member, the abutting portion (the end ridge portion) is pressed against the peripheral surface of the image bearer, and toner remaining on the image bearer is dammed and scraped off and removed.

Since the toner manufactured by polymerization method has a small particle diameter and spherical shape, it has become more difficult to remove the toner using the cleaning blade compared to toner manufactured by conventional kneading and milling method. This is because the toner having small particle diameter and high sphericity rubs through the small gap formed between the cleaning blade and the image bearer. One way to prevent rubbing of the toner is to increase the abutting pressure between the image bearer and the cleaning blade. However, increasing the abutting pressure causes the blade to turn over. In addition, if the cleaning blade is used in a turned-over state, local wear occurs, resulting in shortening of the life of the cleaning blade, cleaning defects and easy generation of abnormal images. Various other studies have been conducted on cleaning performance member. However, no universal solution has been specified. The presence of large coarse particles with large particle sizes makes it difficult for abrasion to occur, but abnormal images occur more likely. In addition, the smaller the volume average particle size, the more likely the cleaning failure occurs due to the increase of rubbed particles.

JP2022103861A discloses image development that can prevent white streaks by reducing the content of coarse particles having a relatively high circularity. However, it does not adequately disclose a definition of coarse particles that can guarantee abnormal images (black squares) and cleaning properties.

An object of the present disclosure is to provide a toner that can achieve both high cleaning properties and high-quality images.

### SUMMARY OF THE DISCLOSURE

In one embodiment, a toner comprises at least a binder resin,, a volume average particle diameter of the toner particles is 4.0 μm or more and less than 6.0 μm, wherein the number of coarse particles defined as follows in 10 mg of the toner is 10 or more and 250 or less.

According to the present disclosure, it is possible to provide a toner that can achieve both high cleaning performance and high-quality images.

### BRIEF DESCRIPTION OF THE DRAWINGS

FIG. 1 is a schematic view illustrating an example of an image forming apparatus using the toner of the present disclosure;

FIG. 2 is a schematic view illustrating another example of the image forming apparatus using the toner of the present disclosure;

FIG. 3 is an enlarged partial view of FIG. 2; and

FIG. 4 is a schematic view illustrating an example of a process cartridge.

### DESCRIPTION OF THE PREFERRED EMBODIMENTS

Hereinafter, the toner, the developer, the toner storage container, the image forming apparatus, and the image forming method according to the present disclosure will be described with reference to the drawings as appropriate. It should be noted that the present disclosure is not limited to the following embodiments, but may be modified within the scope envisioned by a person skilled in the art, such as other embodiments, additions, modifications, and deletions, and is included in the scope of the present disclosure insofar as the working and effects of the present disclosure are achieved in any of the embodiments.

The toner according to the disclosure is comprised of toner base particles comprising binding resins, optionally colorants, a wax, and external additives or the like.

### Toner Base Particles

The toner base particles include at least binder resins and colorants, and optionally other ingredients.

Preferably, the toner base particles are obtained by dissolving or dispersing at least the binder resin and the colorant in an organic solvent, adding the resulting dissolved or dispersed product into aqueous phase, and removing the organic solvent from the resulting dispersion liquid. It is also more preferably obtained by dissolving or dispersing at least the binder resin precursor and colorant in an organic solvent and adding the resulting dissolution or dispersion into aqueous phase to cross-link or extend the binder resin precursor and remove the organic solvent.

### Coarse Particles

The toner of the present invention has between 10 and 250 coarse particles of 20 μm or larger in 10 mg of toner. The number of coarse particles of 20 μm or more is between 15 and 150, and preferably between 15 and 60. The number of coarse particles of 25 μm or more in 2 g of toner is preferably 48 or less, and more preferably 25 or less.

### Volume Average Particle Diameter of Toner

The volume average particle diameter of the toner is between 4.0 μm and 6.0 μm, and preferably between 5.0 μm and 5.5 μm.

The toner base particles typically comprise a polyester resin as a binding resin, preferably a non-linear amorphous polyester, and further preferably a crystalline polyester. Components insoluble in THF usually comprise a non-linear amorphous polyester or a crystalline polyester.

The amorphous polyester resin is obtained by using a polyhydric alcohol component and a multivalent carboxylic acid component such as a multivalent carboxylic acid, a multivalent carboxylic acid anhydride, and a multivalent carboxylic acid ester.

Incidentally, the amorphous polyester resin according to the present disclosure refers to a resin obtained from polyhydric alcohol component and a multivalent carboxylic acid component such as a multivalent carboxylic acid, a multivalent carboxylic acid anhydride, or a multivalent carboxylic acid component, as described above. Resin modified from the polyester resin, such as a prepolymer described below and a resin obtained by crosslinking and/or elongating the prepolymer does not belong to the amorphous polyester resin.

The polyhydric alcohol component include, for example, bisphenol A alkylene (carbon number 2-3) oxide(average addition moles 1-10) adduct, such as polyoxypropylene (2.2)-2,2-bis(4-hydroxyphenyl)propane, polyoxyethylene (2.2)-2,2-bis(4-hydroxyphenyl)propane, ethylene glycol, propylene glycol, neopentyl glycol, glycerin, pentaerythritol, trimethylol propane, hydrogenated bisphenol A, sorbitol, or their alkylene (carbon number 2-3) oxide(average addition moles 1-10) adduct, or the like. They may be used alone or in combination with two or more species.

Examples of the multivalent carboxylic acid component include dicarboxylic acids such as adipic acid, phthalic acid, isophthalic acid, terephthalic acid, fumaric acid, maleic acid; succinic acid substituted with an alkyl group having 1 to 20 carbon atoms such as dodecenylsuccinic acid, octylsuccinic acid, or an alkenyl group having 2 to 20 carbon atoms; trimellitic acid, pyromellitic acid; anhydrides of these acids and alkyl (carbon number: 1 to 8) esters of those acids. They may be used alone or in combination with two or more species.

It is preferable that the amorphous polyester resin is at least partially compatible with the prepolymer described below and the resin obtained by crosslinking and/or extending the prepolymer. By their compatibility, low temperature fixability and hot offset resistance can be improved. Therefore, it is preferable that the polyhydric alcohol component and the multivalent carboxylic acid component constituting the amorphous polyester resin be similar to the polyhydric alcohol component and the multivalent carboxylic acid component constituting the prepolymer to be described later.

The molecular weight of the amorphous polyester resin is not particularly limited and can be appropriately selected depending on the purpose. However, if the molecular weight is too low, the toner may have poor heat storage resistance and durability against stresses such as agitation in the developer, etc, and if the molecular weight is too high, the toner may have high viscoelasticity when melted, resulting in poor low temperature fusing properties. Thus, the weight average molecular weight (Mw) is preferably 2,500 to 10,000, the number average molecular weight (Mn) is preferably 1,000 to 4,000, and the Mw/Mn is preferably 1.0 to 4.0 by GPC measurement.

A glass transition temperature (Tg) of the amorphous polyester resin is not particularly limited, and can be appropriately selected depending on the purpose. However, if the Tg is too low, heat resistance of the toner and resistance to stress such as stirring in the developer may be poor. In the case where the Tg is too high, the viscoelasticity of the toner at the time of melting may be high and the low temperature fixability may be poor. Therefore, it is preferable that the glass transition temperature (Tg) be 40° C. to 70° C. and that the glass transition temperature be more preferably 45° C. to 60° C.

The content of the amorphous polyester resin is not particularly limited and can be appropriately selected depending on the purpose. However, 50 to 95 parts by mass and 60 to 90 parts by mass are preferable relative to 100 parts by mass of the toner. When the content is less than 50 parts by weight, the dispersibility of the pigment and release agent in the toner may deteriorate, resulting in blurring or distortion of the image. When the content is more than 95 parts by mass, the content of the crystalline polyester decreases, and the low temperature fixability may be inferior. If the content is in the more preferred range described above, it is advantageous for high image quality, high stability, and low temperature fixability.

Since the crystalline polyester resin having such properties is used in combination with the amorphous polyester resin, excellent heat-resistant storage stability is obtained at temperatures up to the melt onset temperature owing to the crystallinity of the crystalline polyester resin. At the melt onset temperature, drastic reduction in viscosity (sharp melt) is caused due to melting of the crystalline polyester resin, making the crystalline polyester resin compatible to the amorphous polyester resin. The above-described rapid reduction in the viscosity allows a resulting toner to be fixed. Therefore, the toner having both excellent heat-resistant storage stability and low temperature fixing ability can be provided. Moreover, a desired release range (a difference between the minimum fixing temperature and a hot-offset onset temperature) is also achieved.

The aqueous medium used in the aqueous dispersion liquid is not particularly limited if it is dissolved in water, and can be appropriately selected depending on the purpose. For example, a surfactant (D), a buffering agent, a protective colloid, or the like. They may be used alone or in combination with two or more species.

### Crystalline Polyester Resin

Crystalline polyester resins have units derived from saturated aliphatic diols.

Preferably, the saturated aliphatic diol is an alcohol moiety containing linear aliphatic diols having 2 to 8 carbon atoms.

As a result, the crystalline polyester resin can be evenly finely dispersed in the toner, filming of the crystalline polyester resin is prevented, stress resistance is improved, and low-temperature toner fixability can be achieved.

Since the crystalline polyester resin having such properties is used in combination with the amorphous polyester resin, excellent heat-resistant storage stability is obtained at temperatures up to the melt onset temperature owing to the crystallinity of the crystalline polyester resin. At the melt onset temperature, drastic reduction in viscosity (sharp melt) is caused due to melting of the crystalline polyester resin, making the crystalline polyester resin compatible to the amorphous polyester resin. The above-described rapid reduction in the viscosity allows a resulting toner to be fixed. Therefore, the toner having both excellent heat-resistant storage stability and low temperature fixing ability can be provided. Moreover, a desired release range (a difference between the minimum fixing temperature and a hot-offset onset temperature) is also achieved.

The crystalline polyester resin is obtained with a multivalent alcohol 1 component and a multivalent carboxylic acid anhydride multivalent carboxylic component such as a multivalent carboxylic acid, a multivalent carboxylic acid anhydride, or a multivalent carboxylic acid ester. The crystalline polyester resin according to the present disclosure refers to a resin obtained with a multivalent alcohol component and a multivalent carboxylic acid component, such as a multivalent carboxylic acid, a multivalent carboxylic acid anhydride, or a multivalent carboxylic acid component, as described above. A resin obtained with a modified crystalline polyester resin, for example, a prepolymer as described below and a resin obtained by cross-linking and/or extending the prepolymer do not belong to the crystalline polyester resin.

### Multivalent Alcohol Component

The multivalent alcohol ingredient is not particularly limited and can be appropriately selected depending on the purpose, for example, diol, or a trivalent alcohol.

The diols include, for example, saturated aliphatic diols. Saturated aliphatic diols include linear saturated aliphatic diols, branched saturated aliphatic diols. Among them, linear saturated aliphatic diols are preferred, and linear saturated aliphatic diols having 2 to 8 carbon atoms are more preferred. If the saturated aliphatic diol is branched, the crystallinity of the crystalline polyester resin may be reduced and the melting point may be reduced. In addition, if the number of carbons in the main chain is less than 2, the melting temperature is high and fixing at low temperature is difficult when undergoing condensation polymerization with the aromatic dicarboxylic acid. On the other hand, if the carbon number exceeds 8, practical materials are difficult to obtain. More preferably, the number of carbons is 8 or less.

Saturated aliphatic diols include, for example, ethylene glycol, 1,3-propanediol, 1,4-butanediol, 1,5-pentanediol, 1,6-hexanediol, 1,7-heptanediol, 1,8-octanediol, 1,9-nonandiol, 1,10-decanediol, 1,11-undecandiol, 1,12-dodecanediol, 1,13-tridecanediol, 1,14-tetradecanediol, 1,18-octadecanediol, 1,14-eicosandiol, or the like. Among these, ethylene glycol, 1,3-propanediol, 1,4-butanediol, 1,5-pentanediol, and 1,6-hexanediol are preferable in that the crystalline polyester resin has high crystallinity and excellent sharp melt properties.

Examples of the trivalent or higher alcohol include glycerin, trimethylol ethane, trimethylol propane, pentaerythritol, or the like.

They may be used alone or in combination with two or more.

### Multivalent Carboxylic Acid Component

As the multivalent carboxylic acid component, sebacic acid is used. However, another divalent carboxylic acid or a trivalent or higher carboxylic acid may be used in combination depending on the purpose.

Examples of the divalent carboxylic acids include , for example, saturated aliphatic dicarboxylic acid such as oxalic acid, succinic acid, glutaric acid, adipic acid, speric acid, azelaic acid, sebacic acid, 1,9-nonandicarboxylic acid, 1,10-decanedicarboxylic acid, 1,12-dodecanedicarboxylic acid, 1,14-tetradecandicarboxylic acid, 1,18-octadecanedicarboxylic acid; aromatic dicarboxylic acids, such as dibasic acid (e.g., phthalic acid, isophthalic acid, terephthalic acid, naphthalene-2,6-dicarboxylic acid), malonic acid, dibasic acids, mesaconic acid, or the like; and anhydrides thereof and lower alkyl esters thereof.

Examples of the trivalent or higher carboxylic acids include 1,2,4-benzenetricarboxylic acids, 1,2,5-benzenetricarboxylic acids, 1,2,4-naphthalenetricarboxylic acids, and their anhydrides and lower alkyl esters thereof.

The multivalent carboxylic acid component may include the dicarboxylic acid component having the sulfonic acid group in addition to the saturated aliphatic dicarboxylic acid and the aromatic dicarboxylic acid described above. In addition to the saturated aliphatic dicarboxylic acid and aromatic dicarboxylic acid, the dicarboxylic acid component having a double bond may also be included.

They may be used alone or in combination with two or more.

As the melting point of the crystalline polyester resin, there is no particular limitation, and the melting point can be appropriately selected depending on the purpose. However, it is preferable that the melting point of the crystalline polyester resin be 60° C. or more and not more than 80° C. When the melting point is less than 60° C., the crystalline polyester resin easily melts at a low temperature, and the heat-resistant storage property of the toner may be reduced. When the melting point is 80° C. or more, the low-temperature fixability may be reduced because the polyester resin A is not sufficiently melted by heating at the time of fixing.

The melting point can be measured by the endothermic peak value of the DSC chart in a differential scanning calorimeter (DSC) measurement.

The molecular weight of the crystalline polyester resin is not particularly limited and can be appropriately selected depending on the purpose. However, resins with sharp the molecular weight distribution and low molecular weight have excellent low temperature fixability, and that the heat resistance of the crystalline polyester resin is deteriorated when there are many components with a low molecular weight. Thus the soluble content of ortho-dichlorobenzene of crystalline polyester resin is preferably a weight average molecular weight (Mw) of 3,000 to 30,000 and a number average molecular weight (Mn) of 1,000 to 10,000, and Mw/Mn 1.0 to 10 in a GPC measurement.

The acid value of the crystalline polyester resin is not particularly limited and can be appropriately selected depending on the purpose. However, in order to achieve the desired low temperature fixability from the viewpoint of the affinity between paper and resin, the acid value may be 5 mg KOH/g or more, and optionally 10 mg KOH/g or more. On the other hand, in order to improve the hot offset resistance, it may be 45 mg KOH/g or less.

The hydroxyl group value of the crystalline polyester resin is not particularly limited and can be appropriately selected depending on the purpose. However, in order to achieve the desired low temperature fixability and the good charging property, the hydroxyl group value may be 0 mg KOH/g to 50 mg KOH/g is preferred, and optionally 5 mg KOH/g to 50 mg KOH/g is more.

A molecular structure of the crystalline polyester resin can be confirmed by solution or solid NMR spectroscopy, X-ray diffraction spectroscopy, GC/MS, LC/MS, or IR spectroscopy. As a simple method of confirming the molecule structure of the crystalline polyester resin, there is a method where a compound having absorption, which is based on δCH (out of plane bending) of an olefin, at 965±10 cm⁻¹ or 990±10 cm⁻¹ in an infrared absorption spectrum of the compound is detected as a crystalline polyester resin.

The content of the crystalline polyester resin is not particularly limited and can be appropriately selected depending on the purpose. In one embodiment, 2 to 20 parts by mass and 5 to 15 parts by mass are preferable to the 100 parts by mass of the toner. When the content is less than 2 parts by mass, the low-temperature fixability may be poor due to insufficient sharp melting of crystalline polyester resin. When the content is more than 20 parts by mass, the heat-resistant storage property may deteriorate, and blurred images may easily occur. If the content is in the more preferred range, it is advantageous for high image quality, high stability, and low temperature fixability.

### Inorganic Filler

The toner base particles in the toner according to the present disclosure are manufactured by adding an inorganic filler to the toner base particles described above. As the inorganic filler, one or more kinds selected from calcium carbonate, kaolin clay, talc, barium sulfate, or the like may be added singly or in combination, without being particularly limited.

These inorganic fillers may be surface-treated or the like with silane coupling agents, surfactants, metal stones, or the like, or they may be adjusted to the desired particle size distribution by classification or the like.

In addition to the above, the inorganic fillers contained in the toner of the present disclosure may be laminated inorganic minerals. Optionally, layered inorganic minerals modified with organic ions are used.

The layered inorganic mineral is an inorganic mineral in which layers each having a nanoscale thickness are laminated. Modifying with organic ions means that organic ions are introduced to ions between the layers.

Layered inorganic minerals include the smectites (montmorillonite, saponite, etc.), the kaolins (kaolinite, etc.), the magadiate, and the kanemite.

Denatured layered inorganic minerals are highly hydrophilic because of their denatured layered structure.

Therefore, when the layered inorganic mineral is used for the toner which is dispersed and granulated in the aqueous medium without denaturing, the layered inorganic mineral is transferred to the aqueous medium, and the toner cannot be deformed. However, when the toner is denatured, the hydrophilicity is increased. The modified layered inorganic mineral is micronized and deformed at the time of manufacturing the toner and is particularly abundant on the surface of the toner particles. The toner particles can be uniformly dispersed throughout the toner base particles, thereby performing the charge adjustment function and contributing to fixing at low temperature. At this time, it is preferable that the content of the modified layered inorganic mineral in the toner material be 0.2% to 1.5% by weight.

The modified layered inorganic minerals used in the present disclosure may have a smectite-based basic crystal structure modified with an organic cation. In addition, a metal anion can be introduced by replacing a portion of the divalent metal of the layered inorganic mineral with a trivalent metal. Since the introduction of the metal anion leads to high hydrophilicity, at least a portion of the metal anion may be modified with an organic anion in a layered inorganic compound.

The organic ion modifying agents of the layered inorganic minerals in which at least a part of the ions contained in the layered inorganic minerals are modified with organic ions, include quaternary alkylammonium salts, phosphonium salts, and imidazolium salts. Among them, quaternary alkylammonium salt is preferable. Examples of the quaternary alkylammonium include trimethylstearylammonium, dimethylstearylbenzylammonium, dimethylactadecylammonium, oleylbis(2-hydroxyethyl)methylammonium, or the like.

The organic ion modifying agent further includes sulfates, sulfonates, carboxylates, or phosphates having branched, unbranched or cyclic alkyl (C1-C44), alkenyl (C1-C22), alkoxy (C8-C32), hydroxyalkyl (C2-C22), ethylene oxide, propylene oxide, or the like. Carboxylic acids with an ethylene oxide backbone are preferred.

By modifying at least part of the layered inorganic mineral with organic ions, the layered inorganic mineral get adequate hydrophobicity, then the oil phase containing the toner composition and/or the toner composition precursor may have non-tonian viscosity and deform the toner. In one embodiment, the content of the layered inorganic mineral partially modified with organic ions is between 0.2% and 1.5% by weight.

Layered inorganic minerals partially modified with organic ions may be selected as appropriate, including montmorillonite, bentonite, hectorite, attapulgite, sepiolite and mixtures thereof. Among them, montmorillonite or bentonite containing Al element is preferable because the Al element is effective for improving the charging capacity.

Commercial products of layered inorganic minerals partially modified with organic cations include quatanium 18 bentonium such as Bentone 3, Bentone 38, Bentone 38 V (manufactured by Leox, Inc.), Clayton 40, Clayton XL (manufactured by Southern Clay, Inc.), Thiersogel VP (manufactured by United Catalyst), Clayton 34, Clayton 40, Clayton XL (manufactured by Southern Clay, Inc.); stearal conium bentonite such as Bentone 27 (manufactured by Leox, Inc.), Tixogel LG (manufactured by United Catalyst), Clayton AF, and Claiton APA (manufactured by Southern Clay, Inc.); quatanium 18/benzalkonium bentonium bentonite such as Clayton HT, Clayton PS (manufactured by Southern Clay, Inc.), etc.

Clayton AF and Clayton APA are particularly preferred. As a layered inorganic mineral partially modified with an organic anion, it is particularly preferable that DHT-4A (manufactured by Kyowa Chemical Industry Co., Ltd.) be modified with an organic anion represented by the following general formula (3).

The following general formula (3) includes, for example, hytenol 330T (manufactured by Daiichi Kogyo Pharmaceutical Co., Ltd.).

R₁(OR₂)nOO₃M (3)

[In the above formula, R1 represents an alkyl group having 13 carbons, R2 represents an alkylene group having 2 to 6 carbons, n represents an integer from 2 to 10, and M represents a monovalent metallic element.]

### Other Ingredients

The other ingredients include, for example, release agent, colorant, polymer having a site reactive with the active hydrogen group-containing compound, active hydrogen group-containing compound, charge-controlling agent, external additive, flowability improver, cleaning improvement agent, magnetic material, or the like, which are not particularly limited and may be selected depending on the purpose.

### Release Agent

The release agent may be a wax-based release agent. Examples of the wax-based release agent include natural wax, such as vegetable wax (e.g., carnauba wax, cotton wax, Japanese wax, and rice wax), animal wax (e.g., bees wax and lanolin wax), mineral wax (e.g., ozocerite and ceresin), and petroleum wax (e.g., paraffin wax, microcrystalline wax, and petrolatum wax).

In addition to these natural wax, synthetic hydrocarbon waxes such as Fischer-Tropsch wax, polyethylene, polypropylene, or the like; synthetic waxes such as esters, ketones, ethers or the like; or the like can be used.

In addition, a fatty amide compound, such as a 12-hydroxystearate amide, stearate amide, phthalate anhydride imide, chlorinated hydrocarbon; a homopolymer or copolymer of polyacrylates, such as poly-n-stearylmethacrylate and poly-n-lauryl methacrylate(e.g., a copolymer of n-stearyl acrylate-ethyl methacrylate), which is a low molecular weight crystalline polymer resin; a crystalline polymer having a long alkyl group on the side chain; or the like may be used.

Among these, hydrocarbon-based waxes such as paraffin wax, microcrystalline wax, Fischer-Tropsch wax, polyethylene wax, polypropylene wax, or the like are preferred.

A melting point of the release agent is not particularly limited and may be appropriately selected in accordance with the intended purpose. The melting point of the release agent is preferably 60° C. or higher and lower than 95° C.

The release agent is more preferably hydrocarbon wax having a melting point of 60° C. or higher and lower than 95° C. Such a release agent effectively acts as a release agent at an interface between a fixing roller and the toner, thus hot offset resistance is improved without applying a release agent (e.g., oil) onto the fixing roller.

Particularly, hydrocarbon-based wax is preferable because the hydrocarbon-based wax is not very compatible with the polyester resin A and the hydrocarbon-based wax and the polyester resin A each independently function so that a softening effect of the crystalline polyester resin as a binder resin and offset resistance owing to the release agent are both assured.

When the melting point of the release agent is lower than 60° C., the release agent tends to melt at a low temperature, thus heat-resistant storage stability of a resulting toner may be inadequate. When the melting point of the release agent is 95° C. or higher, the release agent may not be sufficiently melted by heat applied during fixing and thus adequate offset resistance may not be achieved.

An amount of the release agent is not particularly limited, and may be appropriately selected in accordance with the intended purpose. The amount of the release agent is preferably from 2 parts by mass through 10 parts by mass, and more preferably 3 parts by mass through 8 parts by mass, relative to 100 parts by mass of the toner. When the amount of the release agent is less than 2 parts by mass, hot offset resistance of a resulting toner during fixing and low-temperature fixability of the toner may be impaired. When the amount of the release agent is greater than 10 parts by mass, heat-resistant storage stability of a resulting toner may be impaired, and image fogging may occur. When the amount of the release agent is within the above-mentioned more preferable range, higher image quality can be achieved, and fixing stability of a resulting toner improves.

### Colorant

The colorant is not particularly limited and may be appropriately selected in accordance with the intended purpose. Examples of the colorant include carbon black, a nigrosine dye, iron black, naphthol yellow S, Hansa yellow (10G, 5G, G), cadmium yellow, yellow iron oxide, yellow ocher, yellow lead, titanium yellow, polyazo yellow, oil yellow, Hansa yellow (GR, A, RN, R), pigment yellow L, benzidine yellow (G, GR), permanent yellow (NCG), Vulcan fast yellow (5G, R), tartrazine lake, quinoline yellow lake, anthrasan yellow BGL, isoindolinon yellow, red iron oxide, red lead, lead vermilion, cadmium red, cadmium mercury red, antimony vermilion, permanent red 4R, parared, fiser red, parachloroorthonitro aniline red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red F5R, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, and lithopone.

An amount of the colorant is not particularly limited, and may be appropriately selected in accordance with the intended purpose. The amount of the colorant is preferably from 1 part by mass through 15 parts by mass, and more preferably from 3 parts by mass through 10 parts by mass, relative to 100 parts by mass of the toner.

The colorant may be also used as a master batch in which the colorant forms a composite with a resin. Examples of the resin used for production of the master batch, or the resin kneaded together with the master batch include, in addition to the above-mentioned hybrid resin, polymers of styrene or substituted styrene [e.g., polystyrene, poly(p-chlorostyrene), and polyvinyl toluene], styrene-based copolymers (e.g., a styrene-p-chlorostyrene copolymer, a styrene-propylene copolymer, a styrene-vinyl toluene copolymer, a styrene-vinyl naphthalene copolymer, a styrene-methyl acrylate copolymer, a styrene-ethyl acrylate copolymer, a styrene-butyl acrylate copolymer, a styrene-octyl acrylate copolymer, a styrene-methyl methacrylate copolymer, a styrene-ethyl methacrylate copolymer, a styrene-butyl methacrylate copolymer, a styrene-methyl a-chloromethacrylate copolymer, a styrene-acrylonitrile copolymer, a styrene-methyl vinyl ketone copolymer, a styrene-butadiene copolymer, a styrene-isoprene copolymer, a styrene-acrylonitrile-indene copolymer, a styrene-maleic acid copolymer, and a styrene-maleic acid ester copolymer), polymethyl methacrylate, polybutyl methacrylate, polyvinyl chloride, polyvinyl acetate, polyethylene, polypropylene, polyester, an epoxy resin, an epoxypolyol resin, polyurethane, polyamide, polyvinyl butyral, a polyacrylic resin, rosin, modified rosin, a terpene resin, an aliphatic or alicyclic hydrocarbon resin, an aromatic petroleum resin, chlorinated paraffin, and paraffin wax. The above-listed examples may be used alone or in combination.

The master batch can be prepared by applying high shear force to a resin and colorant used for a master batch to mix and knead the mixture. In order to enhance the interaction between the colorant and the resin, an organic solvent may be used. Moreover, a flashing method is preferably used, since a wet cake of the colorant can be directly used without being dried. The flashing method is a method where an aqueous paste containing a colorant is mixed or kneaded with a resin and an organic solvent, and then the colorant is transferred into the resin, followed by removing the moisture and the organic solvent. A high-shearing disperser (e.g., a three-roll mill) is preferably used for the mixing and kneading.

Polymer having a site reactive with an active hydrogen group containing compound(prepolymer) Polymers having a site reactive with an active hydrogen group-containing compounds (sometimes referred to as “prepolymers”) are not particularly limited and may be selected according to the purpose. Examples of the prepolymer include polyol resin, polyacrylic resin, polyester resin, epoxy resin, derivatives thereof, or the like. They may be used alone or in combination with two or more species.

Among these, polyester resins are preferred considering high flowability as a resulting toner is melted and transparency.

Examples of the site of the prepolymer reactive with the active hydrogen group-containing compound include an isocyanate group, an epoxy group, a carboxyl group, and a functional group represented by —COCl. The above-listed examples may be used alone or in combination. Among the above-listed examples, an isocyanate group is preferable.

The prepolymer is not particularly limited and can be appropriately selected depending on the purpose. The prepolymer is preferably a polyester resin including an isocyanate group that can generate a urea bond because a molecular weight of a resulting polymer component is easily adjusted, and excellent release properties and fixability are assured with oil-less low-temperature fixing using a dry toner, particularly even in a case where a release-oil application system for applying release oil to a heating member used for fixing is absent.

### Active Hydrogen Group-Containing Compound

The active hydrogen group-containing compound acts as an elongation agent or a crosslinking agent during an elongation reaction or a cross-linking reaction of the prepolymer performed in an aqueous medium.

The active hydrogen group is not particularly limited and can be appropriately selected depending on the purpose. Examples of active hydrogen group includes, for example, a hydroxyl group (alcoholic hydroxyl group and phenolic hydroxyl group), an amino group, a carboxyl group, a mercapto group, or the like. They may be used alone or in combination with two or more species.

The active hydrogen group-containing compound is not particularly limited and can be appropriately selected depending on the purpose. When the polymer having a site reactive with the active hydrogen group-containing compound is a polyester resin containing an isocyanate group, the amines are preferable considering the polymer can be polymerized by an extension reaction, a cross-linking reaction, or the like with the polyester resin. The amines include, for example, diamines, trivalent or higher amines, amino alcohols, amino mercaptans, amino acids, blocks of these amino groups, or the like. They may be used alone or in combination with two or more species.

Among these, a diamine or a mixture of a diamine and a small amount of a trivalent or more amine is optionally used.

Examples of the diamine are not particularly limited and may be appropriately selected in accordance with the intended purpose. Examples of the diamine include an aromatic diamine, an alicyclic diamine, and an aliphatic diamine.

The aromatic diamine is not particularly limited and may be appropriately selected in accordance with the intended purpose. Examples of the aromatic diamine include phenylene diamine, diethyltoluene diamine, and 4,4′-diaminodiphenylmethane.

The alicyclic diamine is not particularly limited and may be appropriately selected in accordance with the intended purpose. Examples of the alicyclic diamine include 4,4′-diamino-3,3′-dimethyldicyclohexylmethane, diaminocyclohexane, and isophorone diamine.

The aliphatic diamine is not particularly limited and may be appropriately selected in accordance with the intended purpose. Examples of the aliphatic diamine include ethylene diamine, tetramethylene diamine, and hexamethylene diamine.

The trivalent or higher amine is not particularly limited and may be appropriately selected in accordance with the intended purpose. Examples of the trivalent or higher amine include diethylene triamine, and triethylene tetramine.

The amino alcohol is not particularly limited and may be appropriately selected in accordance with the intended purpose. Examples of the amino alcohol include ethanol amine, and hydroxyethylaniline. The amino mercaptan is not particularly limited and may be appropriately selected in accordance with the intended purpose. Examples of the amino mercaptan include aminoethyl mercaptan, and aminopropyl mercaptan.

The amino acid is not particularly limited and may be appropriately selected in accordance with the intended purpose. Examples of the amino acid include amino propionic acid, and amino caproic acid.

The amine in which an amino group is blocked is not particularly limited, and may be appropriately selected in accordance with the intended purpose. Examples of the amine in which an amino group is blocked include ketimine compounds and oxazoline compounds obtained by blocking an amino group with any of ketones, such as acetone, methyl ethyl ketone, and methyl isobutyl ketone.

The Isocyanate Group-Containing Polyester Resin

The isocyanate group-containing polyester resin (may be referred to as a “isocyanate group-containing polyester prepolymer”) is not particularly limited and may be appropriately selected in accordance with the intended purpose. Examples of the isocyanate group-containing polyester resin include a reaction product between an active hydrogen group-containing polyester and a polyisocyanate, where the active hydrogen group-containing polyester is obtained through polycondensation between a polyol and a polycarboxylic acid.

### Polyol

The polyol is not particularly limited and may be appropriately selected in accordance with the intended purpose. Examples of the polyol include a diol, a trivalent or higher alcohol, and a mixture of a diol and a trivalent or higher alcohol. The above-listed examples may be used alone or in combination.

Among the above-listed examples, a diol, and a mixture including a diol and a small amount of a trivalent or higher alcohol are preferable.

The diol is not particularly limited and may be appropriately selected in accordance with the intended purpose. Examples of the diol include: an alkylene glycol, such as ethylene glycol, 1,2-propyleneglycol, 1,3-propyleneglycol, 1,4-butanediol, and 1,6-hexanediol; an oxyalkylene group-containing diol, such as diethylene glycol, triethylene glycol, dipropylene glycol, polyethylene glycol, polypropylene glycol, and polytetramethylene glycol; an alicyclic diol, such as 1,4-cyclohexanedimethanol, and hydrogenated bisphenol A; an alkylene oxide (e.g., ethylene oxide, propylene oxide, and butylene oxide) adduct of alicyclic diol; bisphenols, such as bisphenol A, bisphenol F, and bisphenol S; and a bisphenol alkylene oxide adduct, such as an alkylene oxide (e.g., ethylene oxide, propylene oxide, and butylene oxide) of bisphenol. The number of carbon atoms in the alkylene glycol is not particularly limited, and may be appropriately selected in accordance with the intended purpose. The number of carbon atoms is preferably from 2 through 12. Among the above-listed examples, a C2-C12 alkylene glycol, and a bisphenol alkylene oxide adduct are preferable, and a bisphenol alkylene oxide adduct, and a mixture of a bisphenol alkylene oxide adduct and a C2-C12 alkylene glycol are more preferable.

The trivalent or higher alcohol is not particularly limited and may be appropriately selected in accordance with the intended purpose. Examples of the trivalent or higher alcohol include a trivalent or higher aliphatic alcohol, trivalent or higher polyphenols, and a trivalent or higher polyphenol alkylene oxide adduct.

The trivalent or higher aliphatic alcohol is not particularly limited and may be appropriately selected in accordance with the intended purpose. Examples of the trivalent or higher aliphatic alcohol include glycerin, trimethylol ethane, trimethylolpropane, pentaerythritol, and sorbitol. The trivalent or higher polyphenols are not particularly limited, and may be appropriately selected in accordance with the intended purpose. Examples of the trivalent or higher polyphenols include trisphenol PA, phenol novolac, and cresol novolac.

Examples of the trivalent or higher polyphenol alkylene oxide adduct include alkylene oxide (e.g., ethylene oxide, propylene oxide, and butylene oxide) adducts of trivalent or higher polyphenols.

When the diol and the trivalent or higher alcohol are used as a mixture, a mass ratio of the trivalent or higher alcohol to the diol is not particularly limited, and may be appropriately selected in accordance with the intended purpose. The mass ratio is preferably from 0.01% by mass through 10% by mass, and more preferably from 0.01% by mass through 1% by mass.

### Polycarboxylic Acid

The polycarboxylic acid is not particularly limited and may be appropriately selected in accordance with the intended purpose. Examples of the polycarboxylic acid include a dicarboxylic acid, a trivalent or higher carboxylic acid, and a mixture of a dicarboxylic acid and a trivalent or higher carboxylic acid. The above-listed examples may be used alone or in combination.

Among the above-listed examples, a dicarboxylic acid, and a mixture including a dicarboxylic acid and a small amount of a trivalent or higher carboxylic acid are preferable.

The dicarboxylic acid is not particularly limited and may be appropriately selected depending on the purpose, for example, divalent alkanoic acid, divalent alkenoic acid, aromatic dicarboxylic acid, or the like.

The divalent alkanoic acid is not particularly limited and can be appropriately selected depending on the purpose, for example, succinic acid, adipic acid, sebacic acid, or the like.

The divalent alkenoic acid is not particularly limited and can be appropriately selected depending on the purpose. The divalent alkenoic acid is optionally a divalent alkenoic acid having 4 to 20 carbons. The divalent alkenoic acids having 4 to 20 carbons are not particularly limited and may be selected depending on the purpose, for example, maleic acid, fumaric acid, or the like.

The aromatic dicarboxylic acid is not particularly limited and can be appropriately selected depending on the purpose. The aromatic dicarboxylic acid may be the aromatic dicarboxylic acid having 8 to 20 carbons. The aromatic dicarboxylic acids having 8 to 20 carbons are not particularly limited and may be selected according to the purpose, for example, phthalic acid, isophthalic acid, terephthalic acid, naphthalenedicarboxylic acid, or the like.

The trivalent or higher carboxylic acid is not particularly limited and may be appropriately selected depending on the purpose, for example, an trivalent or higher aromatic carboxylic acid having the [symbol] . The trivalent or higher aromatic carboxylic acids is not particularly limited and can be appropriately selected depending on the purpose, for example, a trivalent aromatic carboxylic acid The trivalent or higher aromatic carboxylic acid may be an aromatic carboxylic acids having 9 to 20 carbons. Aromatic carboxylic acids having 9 to 20 carbons or more are not particularly limited and may be selected according to the purpose, for example, trimellitic acid, pyromellitic acid, or the like.

As the polycarboxylic acid, an acid anhydride or lower alkyl ester of any of a dicarboxylic acid, a trivalent or higher carboxylic acid, or a mixture including a dicarboxylic acid and a trivalent or higher carboxylic acid may be used.

The lower alkyl ester is not particularly limited and may be appropriately selected in accordance with the intended purpose. Examples of the lower alkyl ester include a methyl ester, an ethyl ester, and an isopropyl ester.

When the dicarboxylic acid and the trivalent or higher carboxylic acid are used as a mixture, a mass ratio of the trivalent or higher carboxylic acid to the dicarboxylic acid is not particularly limited, and may be appropriately selected in accordance with the intended purpose. The mass ratio is preferably from 0.01% by mass through 10% by mass, and more preferably from 0.01% by mass through 1% by mass.

When the polyol and the polycarboxylic acid are reacted through polycondensation, an equivalent ratio of a hydroxyl group of the polyol to a carboxyl group of the polycarboxylic acid is not particularly limited, and may be appropriately selected in accordance with the intended purpose. The equivalent ratio is preferably from 1 through 2, more preferably from 1 through 1.5, and particularly preferably from 1.02 through 1.3.

An amount of the constituent unit derived from the polyol in the isocyanate group-containing polyester prepolymer is not particularly limited, and may be appropriately selected in accordance with the intended purpose. The amount of the constituent unit is preferably from 0.5% by mass through 40% by mass, more preferably from 1% by mass through 30% by mass, and particularly preferably from 2% by mass through 20% by mass.

When the amount of the constituent unit is less than 0.5% by mass, hot offset resistance of a resulting toner may be impaired, and it may be difficult to achieve both heat-resistant storage stability and low-temperature fixability of the toner. When the amount of the constituent unit is greater than 40% by mass, low-temperature fixability of a resulting toner may be impaired.

### Polyisocyanate

The polyisocyanate is not particularly limited and may be appropriately selected in accordance with the intended purpose. Examples of the polyisocyanate include an aliphatic diisocyanate, an alicyclic diisocyanate, an aromatic diisocyanate, an aromatic aliphatic diisocyanate, isocyanurate, and products obtained by blocking the above-listed polyisocyanates with a phenol derivative, oxime, or caprolactam.

The aliphatic diisocyanate is not particularly limited and may be appropriately selected in accordance with the intended purpose. Examples of the aliphatic diisocyanate include tetramethylene diisocyanate, hexamethylene diisocyanate, 2,6-diisocyanatocaproic acid methyl ester, octamethylene diisocyanate, decamethylene diisocyanate, dodecamethylene diisocyanate, tetradecamethylene diisocyanate, trimethylhexane diisocyanate, and tetramethylhexane diisocyanate.

The alicyclic diisocyanate is not particularly limited and may be appropriately selected in accordance with the intended purpose. Examples of the alicyclic diisocyanate include isophorone diisocyanate, and cyclohexylmethane diisocyanate.

The aromatic diisocyanate is not particularly limited and may be appropriately selected in accordance with the intended purpose. Examples of the aromatic diisocyanate include tolylene diisocyanate, diisocyanatodiphenyl methane, 1,5-naphthylenediisocyanate, 4,4′-diisocyanatodiphenyl, 4,4′-diisocyanato-3,3′-dimethyldiphenyl, 4,4′-diisocyanato-3-methyldiphenylmethane, and 4,4′-diisocyanato-diphenyl ether.

The aromatic aliphatic diisocyanate is not particularly limited and may be appropriately selected in accordance with the intended purpose. Examples of the aromatic aliphatic diisocyanate include α,α,α′,α′-tetramethylxylenediisocyanate.

The isocyanurate is not particularly limited and may be appropriately selected in accordance with the intended purpose. Examples of the isocyanurate include tris(isocyanatoalkyl)isocyanurate, and tris(isocyanatocycloalkyl)isocyanurate. The above-listed examples may be used alone or in combination.

When the polyisocyanate reacts with the polyester resin including a hydroxyl group, an equivalent ratio (NCO/OH) of an isocyanate group of the polyisocyanate to a hydroxyl group of the polyester resin is not particularly limited, and may be appropriately selected in accordance with the intended purpose. The equivalent ratio (NCO/OH) is preferably from 1 through 5, more preferably from 1.2 through 4, and particularly preferably from 1.5 through 3. When the equivalent ratio (NCO/OH) is less than 1, hot offset resistance of a resulting toner may be impaired. When the equivalent ratio (NCO/OH) is greater than 5, low-temperature fixability of a resulting toner may be impaired.

An amount of the constituent unit derived from polyisocyanate in the isocyanate group-containing polyester prepolymer is not particularly limited and may be appropriately selected in accordance with the intended purpose. The amount of the constituent unit is preferably from 0.5% by mass through 40% by mass, more preferably from 1% by mass through 30% by mass, and particularly preferably from 2% by mass through 20% by mass. When the amount of the constituent unit is less than 0.5% by mass, hot offset resistance of a resulting toner may be impaired. When the amount of the constituent unit is greater than 40% by mass, low-temperature fixability of a resulting toner may be impaired.

The average number of isocyanate groups per molecule of the isocyanate group-containing polyester prepolymer is not particularly limited and may be appropriately selected in accordance with the intended purpose. The average number of isocyanate groups is preferably 1 or greater, more preferably from 1.2 through 5, and particularly preferably from 1.5 through 4. When the average number of isocyanate groups is less than 1, a molecular weight of a resulting modified polyester resin is small, and the small molecular weight of the modified polyester resin may lead to inadequate hot offset resistance of a resulting toner.

A mass ratio of the isocyanate group-containing polyester prepolymer to the above-described polyester resin is not particularly limited and may be appropriately selected in accordance with the intended purpose. The polyester resin includes 50 mol % or greater of a propylene oxide adduct of bisphenol in the multivalent alcohol component and has the certain hydroxyl value and acid value. The mass ratio is preferably from 5/95 through 25/75, and more preferably from 10/90 through 25/75. When the mass ratio is less than 5/95, hot offset resistance may be impaired. When the mass ratio is greater than 25/75, low-temperature fixability or glossiness of an image may be impaired.

### Charge-Controlling Agent

The charge-controlling agent is not particularly limited and may be appropriately selected in accordance with the intended purpose. Examples of the charge-controlling agent include a nigrosine-based dye, a triphenylmethane-based dye, a chrome-containing metal complex dye, a molybdic acid chelate pigment, a rhodamine-based dye, an alkoxy-based amine, a quaternary ammonium salt (including fluorine-modified quaternary ammonium), an alkylamide, phosphorus or a phosphorus compound, tungsten or a tungsten compound, a fluorosurfactant, a metal salt of salicylic acid, and a metal salt of a salicylic acid derivative. Specific examples of the charge-controlling agent include: nigrosine dye BONTRON 03, quaternary ammonium salt BONTRON P-51, metal-containing azo dye BONTRON S-34, oxynaphthoic acid-based metal complex E-82, salicylic acid-based metal complex E-84, and phenol condensate E-89 (all manufactured by ORIENT CHEMICAL INDUSTRIES CO., LTD); quaternary ammonium salt molybdenum complex TP-302 and TP-415 (all manufactured by Hodogaya Chemical Co., Ltd.); LRA-901, and boron complex LR-147 (manufactured by Japan Carlit Co., Ltd.); copper phthalocyanine; perylene; quinacridone; an azo pigment; and a polymer compound including a functional group, such as a sulfonic acid group, a carboxyl group, and a quaternary ammonium salt.

An amount of the charge-controlling agent is not particularly limited and may be appropriately selected in accordance with the intended purpose. The amount of the charge-controlling agent is preferably from 0.1 parts by mass through 10 parts by mass, and more preferably from 0.2 parts by mass through 5 parts by mass relative to 100 parts by mass of the toner. When the amount of the charge-controlling agent is greater than 10 parts by mass, excessive chargeability may be imparted to a resulting toner, and the excessive chargeability may impair a main effect as the charge-controlling agent. As a result, the electrostatic attraction force between the toner and the developing roller increases, which lowers flowability of a developer or reduces image density of an image formed with the toner. The charge-controlling agent may be melt-kneaded with a master batch or resin, followed by dissolving or dispersing the charge-controlling agent in the master batch or the resin, or may be directly added to an organic solvent when the master batch or resin is dissolved or dispersed in the organic solvent. Alternatively, the charge-controlling agent may be fixed on surfaces of toner base particles after producing the toner base particles.

The acid value of the toner is not particularly limited and may be appropriately selected depending on the purpose. The acid value may be from 0.5 mg KOH/g through 40 mg KOH/g from the viewpoint of controlling low temperature fixability (fixing lower limit temperature), hot offset generation temperature, or the like. When the acid value is less than 0.5 mg KOH/g, the effect of improving dispersion stability by the base during production cannot be obtained, and when the prepolymer is used, the elongation reaction and/or crosslinking reaction can easily proceed, resulting in reduced production stability. When the acid value exceeds 40 mg KOH/g, the elongation reaction and/or crosslinking reaction is insufficient when the prepolymer is used, and hot offset resistance may be reduced.

A glass transition temperature (Tg) of the toner is not particularly limited and may be appropriately selected depending on the purpose. In one embodiment, the glass transition temperature (Tg1st) calculated for the first time in the DSC measurement be 45° C. or more and less than 65° C., optionally 50° C. or more and less than 60° C. Thus, low temperature fixability, heat storage resistance, and high durability can be obtained. When the Tg1st is less than 45° C., blocking or filming of the photoconductor may occur in the developing device. When the Tg1st is more than 65° C., the low temperature fixability may be reduced.

In addition, in one embodiment, the glass transition temperature (Tg2nd) of the toner calculated for the second time in the DSC measurement is 20° C. or more and less than 40° C. When the Tg2nd is less than 20° C., blocking or filming of the photoconductor may occur in the developing device, and when the Tg2nd is more than 40° C., the low temperature fixability may be reduced.

### How to Measure Particle Size Distribution

A volume average particle diameter (D4), the number average particle diameter (Dn), and the ratio (D4/Dn) of the toner can be measured using, for example, a Coulter counter TA-II, a Coulter Multi-Sizer II (both manufactured by Coulter Co.), or the like. In one embodiment, a Coulter MultiSizer II was used. The measurement method is described below.

First, 0.1 mL to 5 mL of a surfactant (preferably polyoxyethylene alkyl ether (non-ionic surfactant)) is added as a dispersant to 100 mL to 150 mL of the aqueous electrolyte solution. Here, an electrolytic aqueous solution is a solution of 1 wt % NaCl aqueous solution prepared using primary sodium chloride. For example, ISOTON-II (manufactured by Coulter Co., Ltd.) can be used. Here, an additional 2 mg to 20 mg of the measured sample is added. The electrolytic aqueous solution in which the sample is suspended is dispersed by an ultrasonic dispersor for about 1 to 3 minutes, and the volume distribution and the number distribution are calculated by measuring the volume and number of toner particles or toner using a 100 μm aperture as an aperture by the measuring device. From the obtained distribution, the volume average particle diameter (D4) and the number average particle diameter (Dn) of the toner can be obtained. 13 Channels with 2.00 μm to 2.52 μm; 2.52 μm to 3.17 μm; 3.17 μm to 4.00 μm; 4.00 μm to 5.04 μm; 5.04 μm to 6.35 μm; 6.35 μm to 8.00 μm; 8.00 μm to 10.08 μm; 10.08 μm to 12.70 μm; 12.70 μm to 16.00 μm; 16.00 μm to 20.20 μm; 20.20 μm to 25.40 μm; 25.40 μm to 32.00 μm; were used with particle sizes of 2.00 μm to 40.30 μm.

### External Additives

### Inorganic Particulate

The inorganic particles used as an external additive may be combined with the hydrophobized inorganic particles. In one embodiment, the volume average particle size of the hydrophobized primary particles is 1 nm to 200 nm, optionally 10 nm to 150 nm. The hydrophobized primary particles may contain at least one type of inorganic particles having a volume average particle diameter of 30 nm or less and at least one type of inorganic particles having a volume average diameter of 50 nm or more. When the volume average particle size of the inorganic particles is 50 nm or larger, the blade can easily be dampened, and filming and cleaning can be improved. The specific surface area by the BET method is optionally 20 m2/g to 500 m2/g.

The inorganic particles are not particularly limited and may be appropriately selected according to the purpose, for example, silica fine particles, hydrophobic silica, metal oxides (e.g., titania, alumina, tin oxide, antimony oxide, etc.), fluoropolymers, or the like.

An amount of the inorganic particles is not particularly limited and may be appropriately selected in accordance with the intended purpose. The amount of the inorganic particles is preferably from 0.5 parts by mass through 6.0 parts by weight relative to 100 parts by mass of the toner base particles, and more preferably 1.0 to 4.0 parts by mass.

### Fatty Acid Metal Salt

As an industrial production method of the fatty acid metal salts used as the external additives are a wet process and a dry process. As the wet method, fatty acids is saponified with caustic soda or caustic potassium to form alkali soap, and the alkali soap is reacted with metal salts to form metal stones, As the dry method, fatty acids is reacted with metal oxides or hydroxides to form metal stones.

Examples of a method for atomizing Examples of a method for atomizing the fatty acid metal salt include: a method where dried metal stone obtained by wet milling by dry milling are pulverized in a dry system with high-pressure air; or a method where fatty acid metal salt are dispersed in silicone oil etc. and pulverized in a wet system by means of a bead mill.

The fatty acid metal salts are not particularly limited and include, for example, zinc stearate, aluminum stearate, or the like.

An amount of the fatty acid metal salt is not particularly limited and can be appropriately selected depending on the purpose. In one embodiment, an amount of the fatty acid metal salt is 0.05 to 0.20 parts by mass, optionally 0.08 to 0.16 parts by mass relative to 100 parts by weight of the toner base particles.

### Other External Additives

Other additives include titania, titanium oxide, and fine alumina particles. Examples of titania particles include P-25 (manufactured by Aerosol Japan), STT-30, STT-65C-S (manufactured by Titanium Industry Co., Ltd.), TAF-140 (manufactured by Fuji Titanium Industry Co., Ltd.), MT-150W, MT-500B, MT-600B, MT-150A (manufactured by Teika Co., Ltd.), or the like.

Examples of the hydrophobicity-treated titanium oxide particles include: T-805, available from NIPPON AEROSIL CO., LTD.; STT-30A and STT-65S-S, available from Titan Kogyo, Ltd.; TAF-500T and TAF-1500T, available from Fuji Titanium Industry Co., Ltd .; MT-100S and MT-100T, available from TAYCA CORPORATION; and IT-S, available from ISHIHARA SANGYO KAISHA, LTD.

For acquiring hydrophobicity-treated oxide particles, hydrophobicity-treated silica particles, hydrophobicity-treated titania particles, or hydrophobicity-treated alumina particles, hydrophilic particles may be processed with a silane coupling agent, such as methyltrimethoxysilane, methyltriethoxysilane, and octyltrimethoxysilane. Moreover, silicone oil-processed oxide particles or silicone oil-processed inorganic particles are suitably used. The silicone oil-processed oxide particles or silicone oil-processed inorganic particles are obtained by processing oxide particles or inorganic particles with silicone oil optionally upon application of heat.

Examples of the silicone oil include dimethyl silicone oil, methylphenyl silicone oil, chlorophenyl silicone oil, methylhydrogen silicone oil, alkyl-modified silicone oil, fluorine-modified silicone oil, polyether-modified silicone oil, alcohol-modified silicone oil, amino-modified silicone oil, epoxy-modified silicone oil, epoxy/polyether-modified silicone oil, phenol-modified silicone oil, carboxyl-modified silicone oil, mercapto-modified silicone oil, methacrylic acid-modified silicone oil, and a-methylstyrene-modified silicone oil.

Examples of the inorganic particles include particles of silica, alumina, titanium oxide, barium titanate, magnesium titanate, calcium titanate, strontium titanate, iron oxide, copper oxide, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride. Among the above-listed examples, silica and titanium dioxide are preferable.

An amount of the above-mentioned other external additives is not particularly limited and may be appropriately selected in accordance with the intended purpose. The amount of the above-mentioned other external additives relative to the toner is preferably 0.1% by mass or greater and 5% by mass or less, and more preferably 0.3% by mass or greater and 3% by mass or less. A volume average particle diameter of the primary particles of the inorganic particles is not particularly limited and may be appropriately selected according to the purpose. In one embodiment, the volume average particle diameter of the primary particles of the inorganic particles is 200 nm or less, and optionally 10 nm or more and 100 nm or less. If it is smaller than this range, the inorganic particles are embedded in the toner, and the function of the inorganic particles is difficult to effectively perform. Further, if is larger than this range, the surface of the photoconductor is non-uniformly scratched.

### Other Components

Other components are not particularly limited and may be appropriately selected depending on the purpose. Examples of the other components include a magnetic material, cleaning improvers, flowability improver, charge-controlling agent, or the like.

### Flowability Improver

The flowability improvers may be appropriately selected according to the purpose provided that the surface treatment improves hydrophobicity and deterioration of the flowability characteristic or the charge characteristic can be prevented even under high humidity. The examples of the flowability improvers include, for example, a silane coupling agent, a silylating agent, a silane coupling agent having a fluorinated alkyl group, an organotitanate-based coupling agent, an aluminum-based coupling agent, a silicone oil, a modified silicone oil, or the like. In one embodiment, the silica and the titanium oxide are surface treated with such the flowability improver and used as hydrophobic silica oxide or hydrophobic titanium oxide.

### Cleaning Improver

The cleaning improver is not particularly limited provided that it is added to the toner to remove the developer remaining in the photoconductor or the primary transfer medium after transfer and can be appropriately selected according to the purpose. Examples of the cleaning improver include, for example, fatty acid metal salts such as stearic acid, zinc stearate, or calcium stearate, or the polymer particles manufactured by soap-free emulsion polymerization such as polymethylmethacrylate particles, polystyrene particles, or the like. In one embodiment, the polymer particles have a relatively narrow particle size distribution and have a volume average particle diameter from 0.01 μm through 1 μm.

### Magnetic Material

A magnetic material is not particularly limited and may be appropriately selected depending on the purpose, for example, iron powder, magnetite, ferrite, or the like. Among these, a white color is preferable in terms of color tone.

### Production Method of Toner

A production method of the toner is not particularly limited, and may be appropriately selected in accordance with the intended purpose. The toner is preferably granulated by dispersing an oil phase in an aqueous medium where the oil phase includes at least the amorphous polyester resin, the crystalline polyester resin, the release agent, and the colorant.

Examples of such a production method of the toner include a solution suspension method known in the art.

As another example of the toner production method, a method where toner base particles are formed by generating a product (may be also referred to as an “adhesive base” hereinafter) through an elongation reaction and/or a cross-linking reaction between the active hydrogen group-containing compound and the polymer having a site reactive with the active hydrogen group-containing compound will be described hereinafter. In the method described hereinafter, preparation of an aqueous medium, preparation of an oil phase including toner materials, emulsification or dispersion of the toner materials, removal of an organic solvent etc. are performed.

### Preparation of Aqueous Medium (Aqueous Phase)

For example, the aqueous medium is prepared by dispersing resin particles in an aqueous medium. An amount of the resin particles added to the aqueous medium is not particularly limited and may be appropriately selected in accordance with the intended purpose. The amount of the resin particles is preferably from 0.5% by mass through 10% by mass. The resin particles are not particularly limited and may be appropriately selected in accordance with the intended purpose.

The aqueous medium is not particularly limited, and may be appropriately selected in accordance with the intended purpose. Examples of the aqueous medium include water, a solvent miscible with water, and a mixture of water and a solvent miscible with water. The above-listed examples may be used alone or in combination. Among the above-listed examples, the surfactant is preferable.

The solvent miscible with water is not particularly limited, and may be appropriately selected in accordance with the intended purpose. Examples of the solvent miscible with water include alcohol, dimethylformamide, tetrahydrofuran, cellosolves, and lower ketones.

The alcohol is not particularly limited, and may be appropriately selected in accordance with the intended purpose. Examples of the alcohol include methanol, isopropanol, and ethylene glycol. The lower ketones are not particularly limited, and may be appropriately selected in accordance with the intended purpose. Examples of the lower ketones include acetone, and methyl ethyl ketone.

### Preparation of Oil Phase

The oil phase including the toner materials is prepared by dissolving or dispersing toner materials (i.e., constituent components of toner base particles) in an organic solvent. The toner materials include the active hydrogen group-containing compound, the polymer having a site reactive with the active hydrogen group-containing compound, the crystalline polyester resin, the amorphous polyester resin, the release agent, the hybrid resin, and the colorant.

The organic solvent is not particularly limited, and may be appropriately selected in accordance with the intended purpose. The organic solvent is preferably an organic solvent having a boiling point of lower than 150° C. because such an organic solvent is easily removed. The organic solvent having a boiling point of lower than 150° C. is not particularly limited, and may be appropriately selected in accordance with the intended purpose. Examples of the organic solvent having a boiling point of lower than 150° C. include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. The above-listed examples may be used alone or in combination.

Among the above-listed examples, ethyl acetate, toluene, xylene, benzene, methylene chloride, 1,2-dichloroethane, chloroform, and carbon tetrachloride are preferable, and ethyl acetate is more preferable.

### Emulsification or Dispersion

The emulsification or dispersion of the toner materials is performed by dispersing the oil phase including the toner materials in the aqueous medium. During the emulsification or dispersion of the toner materials, the active hydrogen group-containing compound and the polymer having a site reactive with the active hydrogen group-containing compound are allowed to react through an elongation reaction and/or a cross-linking reaction to synthesize an adhesive base.

For example, the adhesive base is synthesized in the following manner. An oil phase including a polymer reactive with an active hydrogen group (e.g., an isocyanate group-containing polyester prepolymer) is emulsified or dispersed in an aqueous medium together with an active hydrogen group-containing compound (e.g., amines) to react the polymer and the active hydrogen group-containing compound in the aqueous medium through an elongation reaction and/or a cross-linking reaction. Alternatively, an oil phase including constituent materials of toner base particles (may be also referred to as “toner materials”) is emulsified or dispersed in an aqueous medium to which an active hydrogen group-containing compound has been added, and the polymer and the active hydrogen group-containing compound are allowed to react through an elongation reaction and/or a cross-linking reaction in the aqueous medium to synthesize the adhesive base. Moreover, the adhesive base may be synthesized by, after emulsifying or dispersing an oil phase including toner materials in an aqueous medium, adding an active hydrogen group-containing compound, and allowing the polymer and the active hydrogen group-containing compound to react through an elongation reaction and/or a cross-linking reaction at an interface of each particle (e.g., each oil droplet) in the aqueous medium. When the polymer and the active hydrogen group-containing compound are allowed to react through an elongation reaction and/or a cross-linking reaction at an interface of each particle, a urea-modified polyester resin is formed predominantly at a surface of each of the generated toner base particles to give a concentration gradient of the urea-modified polyester resin in each toner base particle.

The reaction conditions (e.g., reaction duration and a reaction temperature) for synthesizing the adhesive base are not particularly limited and may be appropriately selected in accordance with a combination of an active hydrogen group-containing compound and a polymer having a site reactive with the active hydrogen group-containing compound.

The reaction duration is not particularly limited and may be appropriately selected in accordance with the intended purpose. The reaction duration is preferably from 10 minutes through 40 hours, and more preferably from 2 hours through 24 hours.

The reaction temperature is not particularly limited and may be appropriately selected in accordance with the intended purpose. The reaction temperature is preferably from 0° C. through 150° C., and more preferably from 40° C. through 98° C.

A method of stably forming dispersed elements each including the active hydrogen group-containing compound (e.g., an isocyanate group-containing polyester prepolymer) and the polymer having a site reactive with the active hydrogen group containing compound in the aqueous medium is not particularly limited, and may be appropriately selected in accordance with the intended purpose. Examples of the method include a method where an oil phase, which is prepared by dissolving or dispersing toner materials in a solvent, is added to an aqueous medium, and the resulting mixture is dispersed with a shearing force.

A disperser used for the dispersing is not particularly limited and may be appropriately selected in accordance with the intended purpose. Examples of the disperser include a low-speed shearing disperser, a high-speed shearing disperser, a friction disperser, a high-pressure jet disperser, and an ultrasonic disperser.

Among the above-listed examples, a high-speed shearing disperser is preferable as particle diameters of dispersed elements (i.e., oil droplets of the oil phase in the aqueous medium) can be adjusted to a range of from 2 μm to 20 μm. In the case where the high-speed shearing disperser is used, conditions, such as rotational speed, a dispersion time, and a dispersion temperature, are appropriately selected in accordance with the intended purpose.

The rotational speed is not particularly limited and may be appropriately selected in accordance with the intended purpose. The rotational speed is preferably from 1,000 rpm through 30,000 rpm, and more preferably from 5,000 rpm through 20,000 rpm.

The dispersion duration is not particularly limited and may be appropriately selected in accordance with the intended purpose. In case of a batch system, the dispersion duration is preferably from 0.1 minutes through 5 minutes.

The dispersion temperature is not particularly limited and may be appropriately selected in accordance with the intended purpose. The dispersion temperature is preferably from 0° C. through 150° C., and more preferably from 40° C. through 98° C. under pressure. Generally speaking, dispersion is performed easier when the dispersion temperature is a high temperature.

An amount of the aqueous medium used for emulsifying or dispersing the constituent components of the toner base particles (may be also referred to as the “toner materials”) is not particularly limited and may be appropriately selected in accordance with the intended purpose. The amount of the aqueous medium is preferably from 50 parts by mass through 2,000 parts by mass, and more preferably from 100 parts by mass through 1,000 parts by mass, relative to 100 parts by mass of the toner materials.

When the amount of the aqueous medium is less than 50 parts by mass, the toner materials may not be desirably dispersed, consequently not being able to form toner base particles having desired particle diameters. When the amount of the aqueous medium is greater than 2,000 parts by mass, production cost may increase.

When the oil phase including the toner materials is emulsified or dispersed, a dispersing agent is preferably used for stabilizing dispersed elements (e.g., oil droplets) to make particles having desired shapes and a sharp particle size distribution.

The dispersing agent is not particularly limited and may be appropriately selected in accordance with the intended purpose. Examples of the dispersing agent include a surfactant, a poorly water-soluble inorganic compound dispersing agent, and a polymer-based protective colloid. The above-listed examples may be used alone or in combination. Among the above-listed examples, a surfactant is preferable.

The surfactant is not particularly limited and may be appropriately selected in accordance with the intended purpose. Examples of the surfactant include an anionic surfactant, a cationic surfactant, a nonionic surfactant, and an amphoteric surfactant.

The anionic surfactant is not particularly limited and may be appropriately selected in accordance with the intended purpose. Examples of the anionic surfactant include an alkyl benzene sulfonic acid salt, an a-olefin sulfonic acid salt, and a phosphoric acid ester. Among the above-listed examples, a fluoroalkyl group-containing surfactant is preferable.

A catalyst may be used for an elongation reaction and/or a cross-linking reaction for generating the adhesive base.

The catalyst is not particularly limited and may be appropriately selected in accordance with the intended purpose. Examples of the catalyst include dibutyl tin laurate, and dioctyl tin laurate.

### Removal of Organic Solvent

A method of removing the organic solvent from the dispersion liquid, such as emulsified slurry, is not particularly limited, and may be appropriately selected in accordance with the intended purpose. Examples of the method include: a method where an entire reaction system is gradually heated to evaporate the organic solvent in the oil droplets; and a method where the dispersion liquid is sprayed in a dry atmosphere to remove the organic solvent in the oil droplets.

Once the organic solvent is removed, toner base particles are yielded. Washing, drying, etc., may be performed.

The obtained toner base particles may be mixed with other particles, such as the external additive, and the charge-controlling agent. As mechanical impacts are applied to the resulting particle mixture, detachment of the particles of the external additive etc. from surfaces of the toner base particles may be minimized.

A method of applying the mechanical impact is not particularly limited and may be appropriately selected in accordance with the intended purpose. Examples of the method include: a method of applying impact force to the mixture using a blade rotated at high speed; and a method where the mixture is added to a high-speed air flow to accelerate the motion of the particles to make the particles crush into one another or to make the particles crush into a suitable impact board.

A device used for the above-described method is not particularly limited and may be appropriately selected in accordance with the intended purpose. Examples of the device include an angmill (available from HOSOKAWA MICRON CORPORATION), a device obtained by modifying an I-type mill (available from Nippon Pneumatic Mfg. Co., Ltd.) to reduce pulverization air pressure, a hybridization system (available from NARA MACHINERY CO., LTD.), Kryptron System (available from Kawasaki Heavy Industries, Ltd.), and an automatic mortar.

### Classification Process

In the manufacturing of the toner according to the disclosure, classification by sieve may be performed. Classifications by sieve make it possible to control coarse particles that are larger than the sieve aperture. After the drying process, the toner base particles are not flowable, and the processing capacity of the sieve is insufficient. This causes clogging easily.

Therefore, it is preferable that the slurry after forming the toner base particles or the toner after adding the external additive be sieved with a sieve having an opening of 20 μm. The material of the sieve may be varied according to the sieve, but is preferred because nylon, SUS, and polyester are generally available.

### Developer

The developer of the present disclosure includes at least the toner, and may further include appropriately selected other components, such as a carrier.

Since the developer includes the toner of the present disclosure, both excellent transfer properties and excellent cleaning properties are achieved, and high-quality images are stably formed. The developer may be a one-component developer or a two-component developer. In the case where the developer is used for high-speed printers corresponding to the information processing speed that has been improved in recent years, the developer is preferably a two-component developer considering improvement in service life of the developer.

When the developer is a one-component developer, particle diameters of the toner particles do not noticeably vary even after replenishing the developer (i.e., the toner). Therefore, filming of the toner to a developing roller is minimized, or fusion of the toner to a member used for leveling the toner into a thin layer, such as a blade, is reduced. As a result, excellent and stable developing performance and formation of excellent images are assured even after stirring the developer in a developing device over a long period.

When the developer is a two-component developer, particle diameters of the toner particles do not noticeably vary even after replenishing the developer with the toner over a long period. As a result, excellent and stable developing performance and formation of excellent images are assured even after stirring the developer in a developing device over a long period.

When the toner is used for a two-component developer, the toner may be mixed with the carrier. An amount of the carrier in the two-component developer is not particularly limited, and may be appropriately selected by the intended purpose. The amount of the carrier is preferably from 90% by mass through 98% by mass, and more preferably from 93% by mass through 97% by mass.

### Carrier

The carrier is not particularly limited, and may be appropriately selected in accordance with the intended purpose. The carrier includes carrier particles. Each of the carrier particles preferably includes a core particle and a resin layer covering the core particle.

### Core Particles

A material of the core particles is not particularly limited and may be appropriately selected in accordance with the intended purpose. Examples of the material of the core particles include a manganese-strontium-based material of from 50 emu/g through 90 emu/g and a manganese-magnesium-based material of from 50 emu/g through 90 emu/g. Moreover, a hard-magnetic material, such as iron powder of 100 emu/g or greater and magnetite of from 75 emu/g through 120 emu/g for assuring desired image density. Moreover, a soft-magnetic material, such as a copper-zinc-based material of from 30 emu/g through 80 emu/g, is preferably used because the impact of the developer held in the form of a brush (i.e., a magnetic brush) against the photoconductor can be reduced, leading to a high image quality.

The above-listed examples may be used alone or in combination.

A volume average particle diameter of the core particles is not particularly limited and may be appropriately selected in accordance with the intended purpose. The volume average particle diameter of the core particles is preferably from 10 μm through 150 μm, and more preferably from 40 μm through 100 μm.

When the volume average particle diameter of the core particles is less than 10 μm, a proportion of fine particles to the entire amount of the core particles increases, and the increased proportion of the fine particles lowers magnification per particle, consequently causing toner scattering. When the volume average particle diameter of the core particles is greater than 150 μm, a resulting carrier has a small specific surface area, and the carrier having the small specific surface area may cause toner scattering, consequently impairing reproducibility of a solid image, especially in a full-color image having a large solid image area.

### Resin Layer

A material of the resin layer is not particularly limited and may be appropriately selected from resins known in the art. Examples of the material of the resin layer include an amino-based resin, a polyvinyl-based resin, a polystyrene-based resin, a polyhalogenated olefin, a polyester-based resin, a polycarbonate-based resin, polyethylene, polyvinyl fluoride, polyvinylidene fluoride, polytrifluoroethylene, polyhexafluoropropylene, a vinylidene fluoride/acryl monomer copolymer, a vinylidene fluoride/vinyl fluoride copolymer, a fluoroterpolymer made from tetrafluoroethylene, vinylidene fluoride, and a monomer that does not include a fluoro group, and a silicone resin.

The above-listed examples may be used alone or in combination.

The amino-based resin is not particularly limited and may be appropriately selected in accordance with the intended purpose. Examples of the amino-based resin include a urea-formamide resin, a melamine resin, a benzoguanamine resin, a urea resin, a polyamide resin, and an epoxy resin.

The polyvinyl-based resin is not particularly limited and may be appropriately selected in accordance with the intended purpose. Examples of the polyvinyl-based resin include an acrylic resin, polymethyl methacrylate, polyacrylonitrile, polyvinyl acetate, polyvinyl alcohol, and polyvinyl butyral.

The polystyrene-based resin is not particularly limited and may be appropriately selected in accordance with the intended purpose. Examples of the polystyrene-based resin include polystyrene, and a styrene-acryl copolymer.

The polyhalogenated olefin is not particularly limited and may be appropriately selected in accordance with the intended purpose. Examples of the polyhalogenated olefin include polyvinyl chloride.

The polyester-based resin is not particularly limited and may be appropriately selected in accordance with the intended purpose. Examples of the polyester-based resin include polyethylene terephthalate, and polybutylene terephthalate.

The resin layer may optionally include conductive powder. The conductive powder is not particularly limited, and may be appropriately selected in accordance with the intended purpose. Examples of the conductive powder include metal powder, carbon black, titanium oxide, tin oxide, and zinc oxide. The average particle diameter of the conductive powder is preferably 1 μm or less. When the average particle diameter of the conductive layer is greater than 1 μm, it may be difficult to control electric resistance.

The resin layer may be formed by, after dissolving a silicone resin, etc., in a solvent to prepare a coating liquid, applying the coating liquid to surfaces of core particles in accordance with any of coating methods known in the art, and drying the applied coating liquids, followed by baking. The coating methods are not particularly limited and may be appropriately selected in accordance with the intended purpose. Examples of the coating methods include dip coating, spray coating, and brush coating.

The solvent is not particularly limited, and may be appropriately selected in accordance with the intended purpose. Examples of the solvent include toluene, xylene, methyl ethyl ketone, methyl isobutyl ketone, and butyl cellosolve acetate.

The baking may be performed in an external heating system, or in an internal heating system. Examples of the baking include: a method using a fixed electric furnace, a flow electric furnace, a rotary electric furnace, a gas furnace with a furnace burner, etc.; and a method using microwaves.

An amount of the resin layer in the carrier is not particularly limited and may be appropriately selected in accordance with the intended purpose. The amount of the resin layer is preferably from 0.01% by mass through 5.0% by mass. When the amount of the resin layer is less than 0.01% by mass, a resin layer may not be uniformly formed on a surface of each core particle. When the amount of the resin layer is greater than 5.0% by mass, the resulting carrier particles may be fused to one another because the resin layer is thick, consequently impairing homogeneity of the resulting carrier particles.

### Toner Storage Container

The toner storage container of the present disclosure includes a unit configured to store a toner, and the toner of the present disclosure, where the toner is stored in the unit. Examples of an embodiment of the toner storage container include a toner storage container, a developing device, and a process cartridge.

The toner storage container includes a container in which the toner is stored.

The developing device is a unit that contains the toner and is configured to develop an electrostatic latent image with the toner.

### Process Cartridge

A process cartridge discussed in connection with the present disclosure is configured so that the process cartridge is detachably mounted in various image forming apparatuses. The process cartridge includes at least a photoconductor configured to bear an electrostatic latent image, and a developing unit configured to develop the electrostatic latent image borne on the photoconductor with the developer of the present disclosure to form a toner image (may be also referred to as a “visible image”). The process cartridge of the present disclosure may further include other units according to the necessity.

The developing unit includes a developer storage container in which the developer of the present disclosure is stored, and a developer bearing member configured to bear the developer, which is stored in the developer storage container, on a surface of the developer bearing member and to transport the developer. The developing unit may further include a regulating member configured to regulate a thickness of a layer of the developer borne on the developer bearing member.

When the toner storage container is mounted in an image forming apparatus and images are formed by such an image forming apparatus, high-quality and highly-precise images are stably formed over a long period taking advantage of the characteristics of the toner that can achieve excellent hot-offset resistance, charging stability, stress resistance, and background-deposition resistance.

### Image Forming Apparatus and Image Forming Method

The image forming apparatus of the present disclosure includes at least an electrostatic latent image bearer, an electrostatic latent image forming unit, and a developing unit. The image forming apparatus may further include other units according to the necessity.

The image forming method discussed in connection with the present disclosure includes at least forming an electrostatic latent image and developing. The image forming method may further include other steps according to the necessity.

The image forming method is suitably performed by the image forming apparatus. The forming an electrostatic latent image is suitably performed by the electrostatic latent image forming unit. The developing is suitably performed by the developing unit. The above-mentioned other steps may be suitably performed by the above-mentioned other units.

The image forming apparatus of the present disclosure more preferably includes an electrostatic latent image bearer, an electrostatic image forming unit configured to form an electrostatic latent image on the electrostatic latent image bearer, a developing unit that stores a toner and is configured to develop the electrostatic latent image formed on the electrostatic latent image bearer with the toner to form a toner image, a transferring unit configured to transfer the toner image formed on the electrostatic latent image bearer to a surface of a recording medium, and a fixing unit configured to fix the toner image transferred on the surface of the recording medium. Moreover, the image forming method of the present disclosure more preferably includes forming an electrostatic latent image on an electrostatic latent image bearer, developing the electrostatic latent image formed on the electrostatic latent image bearer with a toner to form a toner image, transferring the toner image formed on the electrostatic latent image bearer to a surface of a recording medium, and fixing the toner image transferred to the surface of the recording medium.

The toner is used in the developing unit. Preferably, a developer including the toner and optionally other components, such as a carrier, is used in the developing unit to form the above-described toner image.

### Electrostatic Latent Image Bearer

A material, structure, and size of the electrostatic latent image bearer (may be also referred to as a “photoconductor”) are not particularly limited, and may be appropriately selected from those known in the art. Examples of the material of the electrostatic latent image bearer include inorganic photoconductors (e.g., amorphous silicon, and selenium), and organic photoconductors (e.g., polysilane, and phthalo polymethine).

### Electrostatic Latent Image Forming Unit

The electrostatic latent image forming unit is not particularly limited, provided that the electrostatic latent image forming unit is a unit configured to form an electrostatic latent image on the electrostatic latent image bearer. The electrostatic latent image forming unit may be appropriately selected in accordance with the intended purpose. Examples of the electrostatic latent image forming unit include a unit including a charging member configured to charge a surface of the electrostatic latent image bearer, and an exposing member configured to expose the charged surface of the electrostatic latent image bearer to light to correspond to an image to be formed.

### Developing Unit

The developing unit is not particularly limited provided that the developing unit stores a toner and is configured to develop the electrostatic latent image formed on the electrostatic latent image bearer with the toner to form a visible image. The developing unit may be appropriately selected in accordance with the intended purpose.

### Cleaning Unit

The image forming apparatus of the present disclosure preferably further includes a cleaning unit. As described above, the toner of the present disclosure has excellent cleaning properties. Therefore, cleaning properties are improved further by using the toner in the image forming apparatus including the cleaning unit, as described below.
Even when stress is applied to the toner, flowability of the toner is maintained owing to an improved effect of the toner as a spacer, consequently improving cleaning properties.
When the amount of external additive (silica) free B (mass %) satisfies a formula (3) below, An adequate amount of the external additive is released from the toner on the photoconductor to form a deposited layer (i.e., a dam layer) of the external additive at a nip with a cleaning blade, consequently achieving excellent cleaning properties.

$$0.3 < A < 2. \qquad Formula ( 3 )$$

The cleaning unit is not particularly limited, provided that the cleaning unit is a unit capable of removing the residual toner on the photoconductor. The cleaning unit may be appropriately selected in accordance with the intended purpose. Examples of the cleaning unit include a magnetic brush cleaner, an electrostatic brush cleaner, a magnetic roller cleaner, a blade cleaner, a brush cleaner, and a web cleaner.

### Other Units

Examples of the above-mentioned other units include a transferring unit, a fixing unit, a charge-eliminating unit, a recycling unit, and a controlling unit.

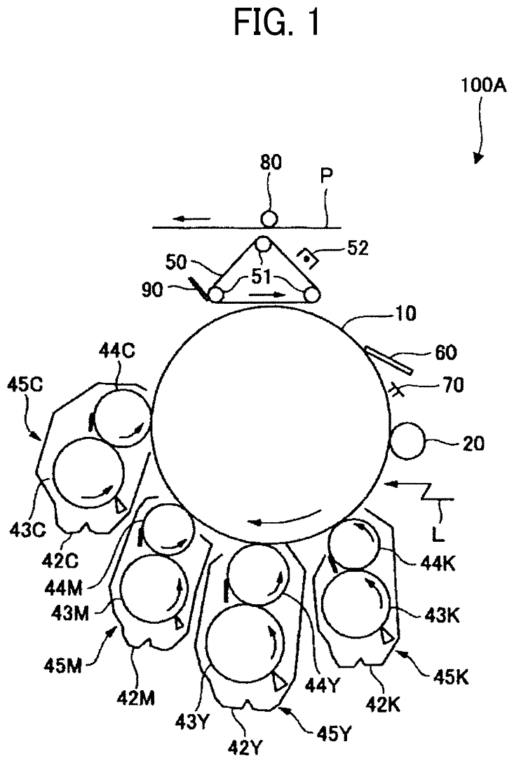

Next, one embodiment for carrying out a method of forming an image using the image forming apparatus of the present disclosure will be described with reference to FIG. 1.

FIG. 1 illustrates an example of the image forming apparatus of the present disclosure. A color image forming apparatus 100A of FIG. 1 includes a photoconductor drum 10 (may be referred to as a “photoconductor 10” hereinafter) serving as the electrostatic latent image bearer, a charging roller 20 serving as the charging unit, an exposure device 30 serving as the exposing unit, a developing device 40 serving as the developing unit, an intermediate transfer member 50, a cleaning device 60 serving as the cleaning unit having a cleaning blade, and a charge-eliminating lamp 70 serving as the charge-eliminating unit.

The intermediate transfer member 50 is an endless belt and is rotatably driven by three rollers 51 in the direction indicated with an arrow in FIG. 1. The three rollers 51 are disposed inside the loop of the endless belt to support the endless belt. Some of the three rollers 51 may also function as a transfer bias roller capable of applying predetermined transfer bias (or primary transfer bias) to the intermediate transfer member 50. The cleaning device 90 including the cleaning blade is disposed closely to the intermediate transfer member 50. Moreover, the transfer roller 80 is disposed closely to the intermediate transfer member 50 in a manner that the transfer roller 80 faces the intermediate transfer member 50. The transfer roller serves as the transferring unit capable of applying transfer bias for transferring (or secondary transferring) the developed image (also referred to as the visible image or the toner image) to transfer paper P serving as the recording medium. The corona charger 52 configured to apply charge to the toner image on the intermediate transfer member 50 is disposed at the periphery of the intermediate transfer member 50. The position of the corona charger 52 is located between a contact area (a) and a contact area (b) relative to the rotational direction of the intermediate transfer member 50, the contact area (a) being a contact area between a photoconductor 10 and the intermediate transfer member 50, and the contact area (b) being a contact area between the intermediate transfer member 50 and the transfer paper P.

A black developing unit 45K, a yellow developing unit 45Y, a magenta developing unit 45M, and a cyan developing unit 45C are disposed at the periphery of the photoconductor drum 10 to directly face the photoconductor drum 10. The black developing unit 45K includes a developer storage container 42K, a developer supply roller 43K, and a developing roller 44K. The yellow developing unit 45Y includes a developer storage container 42Y, a developer supply roller 43Y, and a developing roller 44Y. The magenta developing unit 45M includes a developer storage container 42M, a developer supply roller 43M, and a developing roller 44M. The cyan developing unit 45C includes a developer storage container 42C, a developer supply roller 43C, and a developing roller 44C. Moreover, the developing belt 41 is an endless belt rotatably supported by two or more belt rollers. Part of the developing belt 41 comes into contact with the electrostatic latent image bearer 10.

In the color image forming apparatus 100A of FIG. 1, for example, the charging roller 20 uniformly charges a surface of the photoconductor drum 10. The exposure device 30 exposes the charged surface of the photoconductor drum 10 to light to correspond to an image to be formed to form an electrostatic latent image. The toner is supplied from the developing device 40 to develop the electrostatic latent image formed on the photoconductor drum 10 to form a toner image. Voltage is applied from the roller 51 to the toner image to transfer (or primary transfer) the toner image onto the intermediate transfer member 50, followed by transferring (or secondary transferring) onto transfer paper P. As a result, the transferred image is formed on the transfer paper P. The residual toner on the photoconductor 10 is removed by the cleaning device 60. The residual charge of the photoconductor 10 is temporarily removed by the charge-eliminating lamp 70.

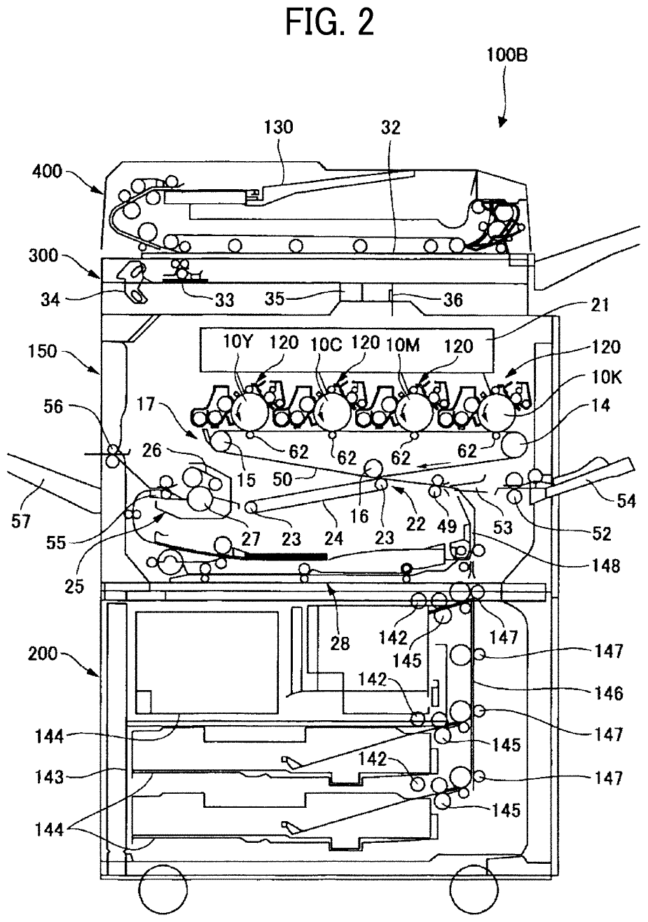

FIG. 2 illustrates another example of the image forming apparatus of the present disclosure. The image forming apparatus 100B of FIG. 2 includes a photocopier main body 150, a paper feeding table 200, a scanner 300, and an automatic document feeder (ADF) 400.

An intermediate transfer member 50, which is an endless belt, is disposed at the central part of the photocopier main body 150. The intermediate transfer member 50 is supported by support rollers 14, 15, and 16, and is rotatably disposed in the clockwise direction in FIG. 2. An intermediate transfer member cleaning device 17 is disposed closely to the support roller 15. The intermediate transfer member cleaning device 17 is configured to remove the residual toner on the intermediate transfer member 50. A tandem developing device 120 is disposed to face the section of the intermediate transfer member 50 supported by the support rollers 14 and 15. In the tandem developing device 120, four image forming units 120, i.e., a yellow image forming unit, a cyan image forming unit, a magenta image forming unit, and a black image forming units, are arranged in series along the travelling direction of the intermediate transfer member 50. An exposure device 21 serving as the exposing member is disposed closely to the tandem developing device 120. A secondary transfer device 22 is disposed to the side of the intermediate transfer member 50 opposite to the side where the tandem developing device 120 is disposed. The secondary transfer device 22 includes a secondary transfer belt 24. The secondary transfer belt 24 is an endless belt and is supported by a pair of rollers 23. Transfer paper borne on and transported by the secondary transfer belt 24 comes into contact with the intermediate transfer member 50. A fixing device 25 serving as the fixing member is disposed closely to the secondary transfer device 22. The fixing device 25 includes a fixing belt 26, which is an endless belt, and a press roller 27 disposed to press against the fixing belt 26.

The tandem image forming apparatus includes a sheet reverser 28 disposed closely to the secondary transfer device 22 and to the fixing device 25. The sheet reverser 28 is configured to reverse transfer paper to perform image formation on both sides of the transfer paper.

Next, formation of a full-color image (i.e., a color copy) using the tandem developing device 120 will be described. First, a document is set on a document table 130 of the automatic document feeder (ADF) 400. Alternatively, a document is set on contact glass 32 of a scanner 300 by opening the automatic document feeder 400. Once the document is set, the automatic document feeder 400 is closed.

Once start switch (not illustrated) is pressed, if the document is set on the automatic document feeder 400, the document is transported onto the contact glass 32, then the scanner 300 is driven. If the document is initially set on the contact glass 32, the scanner 300 is immediately driven once the start switch is pressed. Then, a first carriage 33 and a second carriage 34 are driven to scan the document. During the scanning, the first carriage 33 irradiates a surface of the document with light emitted from a light source, the light reflected from the surface of the document is again reflected by a mirror of the second carriage 34 to pass through an imaging forming lens 35. The light is then received by a reading sensor 36 to read the color document (e.g., the color image) to acquire image information of black, yellow, magenta, and cyan.

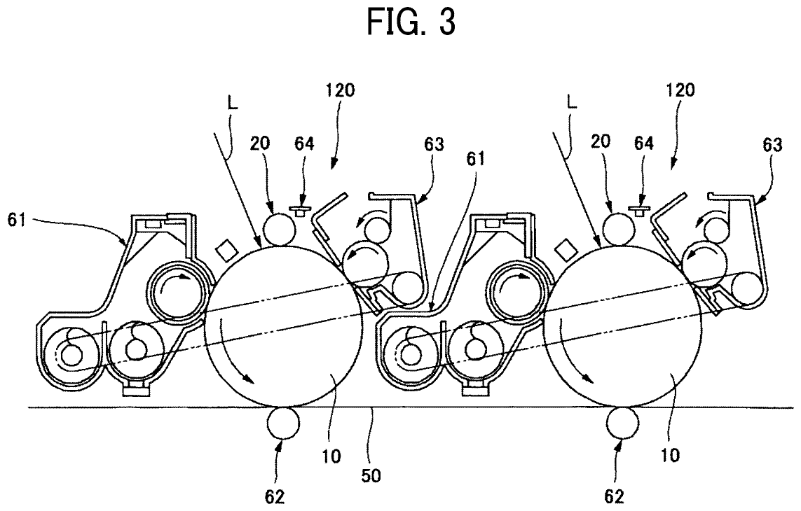

The image information of each of black, yellow, magenta, and cyan is transmitted to the corresponding image forming unit 120 (the black image forming unit, the yellow image forming unit, the magenta image forming unit, or the cyan image forming unit) of the tandem developing device 120. By means of each image forming unit, a toner image of each color (black, yellow, magenta, or cyan) is formed. Specifically, as illustrated in FIG. 3, each image forming unit 120 (the black image forming unit, the yellow image forming unit, the magenta image forming unit, or the cyan image forming unit) of the tandem developing device 120 includes: an electrostatic latent image bearer 10 (a black electrostatic latent image bearer 10K, a yellow electrostatic latent image bearer 10Y, a magenta electrostatic latent image bearer 10M, or a cyan electrostatic latent image bearer 10C); a charging device 20 that is the charging device configured to uniformly charge a surface of the electrostatic latent image bearer 10; an exposure device configured to expose the electrostatic latent image bearer to light (L in FIG. 3) to correspond to each color image based on the corresponding color image information, to thereby form an electrostatic latent image corresponding to each color image on the electrostatic latent image bearer; a developing device 61 configured to develop the electrostatic latent image with the corresponding color toner (the black toner, the yellow toner, the magenta toner, or the cyan toner), to thereby form a toner image of the corresponding color toner; a transfer charger 62 configured to transfer the toner image to an intermediate transfer member 50; a cleaning device 63; and a charge-eliminating unit 64. Each image forming unit 120 can form an image of a single color (e.g., a black image, a yellow image, a magenta image, and a cyan image) based on the corresponding color image information. The black image formed on the black electrostatic latent image bearer 10K, the yellow image formed on the yellow electrostatic latent image bearer 10Y, the magenta image formed on the magenta electrostatic latent image bearer 10M, and the cyan image formed on the cyan electrostatic latent image bearer 10C in the above-described manner are sequentially transferred (or primary transferred) onto the intermediate transfer member 50 that is rotatably supported by the support rollers 14, 15, and 16. The black image, the yellow image, the magenta image, and the cyan image are superimposed on the intermediate transfer member 50 to form a composite color image (i.e., a transferred color image).

In the paper feeding table 200, meanwhile, one of paper feeding rollers 142 is selectively driven to rotate to feed sheets (i.e., recording paper) from one of paper feeding cassettes 144 stacked in a paper bank 143. The sheets are separated one by one by a separation roller 145 to feed each sheet into a paper feeding path 146, and the fed sheet is transported by a transport roller 147 to guide the sheet into a paper feeding path 148 inside the photocopier main body 150. The sheet is then let collide with a registration roller 49 to stop. Alternatively, a paper feeding roller 142 is driven to rotate to feed sheets (i.e., recording paper) on a manual feed tray 54, the sheets are separated and fed into a manual paper feeding path 53 one by one with a separation roller 52. Similarly, the fed sheet is let collide with a registration roller 49 to stop. The registration roller 49 is typically earthed during use, but the registration roller 49 may be used in the state where bias is applied to the registration roller 49 for removing paper dusts from sheets. Synchronizing with the timing of the composite color image (i.e., the transferred color image) formed on the intermediate transfer member 50, the registration roller 49 is driven to rotate to feed the sheet (i.e., the recording paper) between the intermediate transfer member 50 and the secondary transfer device 22. The composite color image (i.e., the transferred color image) is then transferred (or secondary transferred) onto the sheet (i.e., the recording paper) by the secondary transfer device 22. In the manner as described above, the color image is transferred and formed onto the sheet (i.e., the recording paper). After transferring the image, the residual toner on the intermediate transfer member 50 is cleaned by the intermediate transfer member cleaning device 17

The sheet (i.e., the recording paper) on which the color image has been transferred is transported by the secondary transfer device 22 to send the sheet to the fixing device 25. By means of the fixing device 25, heat and pressure are applied to the composite color image (i.e., the transferred color image) to fix the composite color image to the sheet (i.e., the recording paper). Thereafter, the traveling direction of the sheet (i.e., the recording paper) is switched by the switching claw 55 to eject the sheet (i.e., the recording paper) with an ejection roller 56 to stack the sheet (i.e., the recording paper) on the paper ejection tray 57. Alternatively, the traveling direction of the sheet (i.e., the recording paper) is switched by the switching claw 55 and the sheet is flipped by the sheet reverser 28 to send the sheet back to the transfer position. After recording an image also on the back side of the sheet, the sheet is ejected by the ejection roller 56 to stack on the paper ejection tray 57.

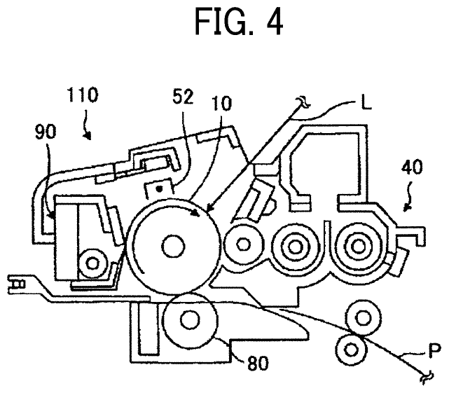

FIG. 4 illustrates an example of the process cartridge discussed in connection with the present disclosure. The process cartridge 110 includes a photoconductor drum 10, a corona discharger 52, a developing device 40, a transfer roller 80, and a cleaning device 90.

### EXAMPLE

The present disclosure will be described below by way of Examples. The present disclosure should not be construed as being limited to these Examples. In Examples, “part(s)” denotes “part(s) by mass” and “%” denotes “% by mass” unless otherwise stated.

### Example 1

### Synthesis of Prepolymer A (Amorphous Polyester Resin A)

A reaction vessel equipped with a stirrer, cooling device, and nitrogen introduction tube was charged with 3-Methyl-1,5-pentanediol, isophthalic acid, adipic acid, and trimellitic anhydride as well as titanium tetraisopropoxide (1,000 ppm for the resin component) so that OH/COOH, the molar ratio of hydroxyl groups to carboxyl groups, is 1.5, the diol component is composed of 100 mol % 3-methyl-1,5-pentanediol, and the dicarboxylic acid component is composed of 40 mol % isophthalic acid and 60 mol % adipic acid. mol % and adipic acid 60 mol %, and the amount of anhydrous trimellitic acid in the total monomer OH/COOH, the molar ratio of hydroxyl groups to carboxyl groups, is 1.5, the diol component is composed of 100 mol % 3-methyl-1,5-pentanediol, and the dicarboxylic acid component is composed of 40 mol % isophthalic acid and 60 mol % adipic acid. mol % and adipic acid 60 mol %, and the amount of anhydrous trimellitic acid in the total monomer

Thereafter, the temperature was increased to 200° C. for about 4 hours, then increased to 230° C. for about 2 hours, and the reaction was carried out until the runoff water disappeared.

Further reaction was performed under reduced pressure from 10 mmHg to 15 mmHg for 5 hours to afford [intermediate polyester A-1].

Then, a reaction vessel equipped with a stirrer, cooling device, and nitrogen introduction tube was charged with the [Intermediate Polyester A-1] and isophorone diisocyanate (IPDI)at a molar ratio (IPDI isocyanate group/intermediate polyester hydroxyl group) of 2.0, and then diluted with ethyl acetate to produce a 50% ethyl acetate solution, and reacted at 100° C. for 5 hours to obtain [Prepolymer A-1].

In addition, in the preparation process of the toner in the examples and the comparative examples to be described later, [polyester resin A] corresponding to the polyester resin component is produced.

### Synthesis of Amorphous Polyester B

A reaction vessel equipped with a stirrer, cooling device, and nitrogen introduction tube was charged with 2 molar adducts of ethylene oxide of bisphenol A, 2 molar adducts of propylene oxide of bisphenol A, terephthalic acid and adipic acid so that OH/COOH, the molar ratio of hydroxyl groups to carboxyl groups, is 1.1, the diol component consists of 80 mol % of bisphenol A 2-mol adduct of ethylene oxide and 20 mol % of bisphenol A 2-mol adduct of propylene oxide, and the dicarboxylic acid component consists of 60 mol % and adipic acid 40 mol %, as well as titanium tetraisopropoxide (1,000 ppm for the resin component). Thereafter, the temperature was increased to 200° C. for about 4 hours, then the temperature was increased to 230° C. for about 2 hours, and the reaction was carried out until the runoff water disappeared. Further reaction was performed under reduced pressure from 10 mmHg to 15 mmHg for 5 hours to afford [intermediate polyester B].

Then, a reaction vessel equipped with a stirrer, cooling device, and nitrogen introduction tube was charged with the [intermediate polyester B] and isophorone diisocyanate (IPDI) at a molar ratio (an isocyanate group of IPDI/an hydroxyl group of the intermediate polyester) of 2.0, and then diluted with ethyl acetate to obtain a 50% ethyl acetate solution, and reacted at 100° C. for 5 hours to obtain [prepolymer B].

In addition, in the process of manufacturing the toner in the examples and the comparison examples described later, the [polyester resin B] corresponding to the polyester resin component is produced.

### Synthesis of Amorphous Polyester Resin C

A four-neck flask equipped with a nitrogen introduction tube, a dehydration tube, a stirrer, and a heat transfer pair was charged with bisphenol A ethylene oxide 2 molar adduct, bisphenol A propylene oxide 3 molar adduct, terephthalic acid, adipic acid, and trimethylol propane, as well as titanium tetraisopropoxide (500 ppm for the resin component) so that a molar ratio of bisphenol A ethylene oxide 2 molar adduct and bisphenol A propylene oxide 3 molar adduct (bisphenol A ethylene oxide 2 molar adduct/bisphenol A propylene oxide 3 molar adduct) was 85/15, a molar ratio of terephthalic acid and adipic acid (terephthalic acid/adipic acid) was 75/25, the amount of trimethylol propane in all monomers was 1 mol %, and the OH/COOH, the molar ratio of hydroxyl groups to carboxyl groups, was 1.2. Thereafter, they were reacted at 230° C. for 8 hours. After a further 4 hours reaction at reduced pressure of 10 mmHg to 15 mmHg, trimellitic anhydride was added to the reaction vessel in an amount of 1 mol % of the total resin component and reacted at 180° C. at atmospheric pressure for 3 hours to obtain [amorphous polyester resin C].

### Synthesis of Crystalline Polyester Resin D

A 5 L 4-neck flask equipped with a nitrogen introduction tube, a dehydration tube, an agitator, and a heat transfer pair was charged with dodecanedioic acid and 1,6-hexanediol so that the OH/COOH, the molar ratio of the hydroxyl group to the carboxyl group, was 0.9, and reacted with titanium tetraisopropoxide (500 ppm relative to the resin component) at 180° C. for 10 hours, then warmed to 200° C. for 3 hours, and reacted at8.3 kPa for 2 hours to obtain [crystalline polyester resin D].

### Preparation of Crystalline Polyester Resin Dispersion

A vessel equipped with a stirred bar and a thermometer set was charged with 50 parts of [crystalline polyester resin D] and 450 parts of ethyl acetate and warmed to 80° C. under stirring, and the temperature was kept at 80° C. for 5 hours. Then, the vessel was cooled to 30° C. for 1 hour. The bead mill (Ultravisco Mill, manufactured by Aimex) was used to fill 80 volumes % of 0.5 mm zirconia beads at a feed rate of 1 kg/hr and a disk circumference rate of 6 m/sec, then dispersed under three passes conditions to obtain [crystalline polyester resin dispersion 1].

### Preparation of Master Batch (MB)

1,200 parts of water, 500 parts of carbon black (manufactured by Printex 35 deca) (amount of DBP oil absorption=42 mL/100 mg, pH=9.5), and 500 parts of [amorphous polyester resin C-1] were mixed by means of a Henschell mixer (manufactured by Mitsui Mining Co., Ltd.). Then the mixture was kneaded using two rolls at 150° C. for 30 minutes, then rolled and cooled, pulverized with a pulpererizer to obtain [Master Batch 1].

### Preparation of WAX Dispersion

A vessel equipped with a stirred bar and a thermometer set was charged with 50 parts of paraffin wax (HNP-9, hydrocarbon wax, melting point 75° C., SP value 8.8) and 450 parts of ethyl acetate and warmed to 80° C. under stirring. The mixture was kept at 80° C. for 5 hours and was cooled to 30° C. for 1 hour. The mixture was dispersed under three-pass conditions using a bead mill (Ultra-Visco Mill, Imex) at a flow rate of 1 kg/hr and a disk circumference of 6 m/sec, with 80 volumes % of 0.5 mm zirconia beads to obtain [WAX dispersion liquid 1].

### Synthesis of Ketimine Compounds

A vessel equipped with a stirred bar and a thermometer set was charged with 170 parts of isophorone diamine and 75 parts of methyl ethyl ketone and reacted at 50° C. for 5 hours to obtain [ketimine compound 1]. The amine value of the [ketimine compound 1] was 418.

### Preparation of Oil Phase

A vessel was charged with 500 parts of the [WAX dispersion liquid 1] and 956 parts of the [crystalline polyester dispersion 1], 76 parts of the [prepolymer A], 152 parts of the [prepolymer B], 836 parts of the [amorphous polyester resin C-1], 100 parts of the [master batch 1], and two parts of the [ketimine compound 1] as a hardener, and mixed by means of a TK homomixer (specially designed) at 5,000 rpm for 60 minutes to obtain [oil phase 1].

### Synthesis of Organic Particle Emulsion (Fine Particle Dispersion)

A reaction vessel equipped with a stir bar and a thermometer set was charged with 683 parts of water, 11 parts of sodium salt of methacrylate ethylene oxide adduct sulfate (eleminol RS-30: manufactured by Sanyo Chemical Co., Ltd.), 138 parts of styrene, 138 parts of methacrylic acid, and 1 part of ammonium persulfate, and stirred for 15 minutes at 400 rpm to obtain a white emulsion. Heated to a system temperature of 75° C._and reacted for 5 hours. Furthermore, 30 parts of 1% aqueous ammonium persulfate solution was added and aged at 75° C. for 5 hours to obtain an aqueous dispersion of a vinyl resin (a copolymer of the sodium salt of styrene-methacrylic acid-ethylene oxide methacrylate adduct sulfate) [fine particle dispersion 1]. The volume average particle diameter measured with LA-920 (manufactured by HORIBA) for [particle dispersion liquid 1] was 0.14 μm. A portion of [particle dispersion liquid 1] was dried to isolate the resin content.

### Preparation of Aqueous Phase

A vessel was charged with 990 parts of water, 83 parts of [particulate dispersion 1], 37 parts of 48.5% aqueous solution of sodium dodecyl diphenyl ether disulfonate (eleminol MON-7: manufactured by Sanyo Chemical Industry Co., Ltd.), and 90 parts of ethyl acetate, and mixed and stirred to obtain a milky white liquid, [aqueous phase 1].

### Emulsification/Solvent

A vessel containing the [oil phase 1] was charged with 1,200 parts of [water phase 1],and mixed with a TK homomixer at 13,000 rpm for 20 minutes to obtain [emulsion slurry 1]. Next, a vessel equipped with a stirrer and a thermometer set was charged with the [emulsion slurry 1] was desolvented for 8 hours at 30° C., then matured at 45° C. for 4 hours to obtain [dispersion slurry 1].

### Classification Process

The resulting slurry was screened with a 20 μm stainless steel test sieve to obtain [Post-Screen Slurry 1].

### Wash and Dry

100 parts of the [Post-sieve slurry 1] were filtered under reduced pressure, and the following procedure was carried out.
(1): The filter cake was mixed with 100 parts of ion-exchanged water (12,000 rpm for 10 minutes) in a TK homomixer and filtered.
(2)100 parts of a 10% aqueous sodium hydroxide solution were added to the filter cake in procedure (1), mixed (at 12,000 rpm for 30 minutes) with a TK homomixer, and filtered in vacuo.
(3)100 parts of 10% hydrochloric acid were added to the filter cake in procedure (2), mixed with a TK homomixer (at 12,000 rpm for 10 minutes), and filtered.
(4)300 parts of ion-exchanged water were added to the filter cake in procedure (3), mixed with a TK homomixer (at 12,000 rpm for 10 minutes), and filtered.

The above procedure from (1) through (4) were performed twice to obtain a [filter cake]. The [filter cake] was dried at 45° C. for 48 hours in a wind recirculation dryer and screened with a mesh having an eye opening of 75 μm [toner base particle 1].

### External Addition Processing

To 100 parts by mass, 2.2 mass parts of hydrophobic silica A having a volume average particle diameter of 160 nm, 1.0 mass parts of titanium oxide having a volume average particle diameter of 20 nm, and 0.8 parts of hydrophobic silica powder having a volume average particle diameter of 15 nm weremixed with a Henschell mixer. [Toner 1] was obtained by sifting them with a 38 μm aperture sieve to remove excess material.

### Preparation of Carrier

100 mass parts of silicone resin (organostrate silicone), 5 mass parts of γ-(2-aminoethyl) aminopropyltrimethoxysilane, and 10 mass parts of carbon black were added to 100 mass parts of toluene and dispersed with a homomixer for 20 minutes to prepare a resin layer coating solution. A fluidized bed coating apparatus was used to apply the resin layer coating solution to the surface of 1,000 mass parts of spherical magnetite having a volume average particle diameter of 50 μm to obtain [carrier].

### Preparation of Developer

A ball mill was used to mix 5 parts of [toner 1] and 95 parts of the [carrier] to prepare [developer 1].

### Example 2

In Example 1, the [toner 2] and the [developer 2] are prepared in the same manner as in Example 1, except that the opening of the sieve in the classification process is changed to 21 μm. This example is prophetic.

### Example 3

In Example 1, the [toner 3] and the [developer 3] were prepared in the same manner as Example 1, except that the opening of the sieve in the classification process was changed to 23 μm.

### Example 4

In Example 1, the [toner 4] and the [developer 4] were prepared in the same manner as Example 1 except that the opening of the sieve in the classification process was changed to 25 μm and the opening of the sieve after external addition treatment was changed to 20 μm.

### Comparative Example 1

In Example 1, the [toner 5] and the [developer 5] were prepared in the same manner as Example 1 except that the opening of the sieve in the classification process was changed to 20 μm and the opening of the sieve after external addition treatment was changed to 20 μm.

### Comparative Example 2

In Example 1, the [toner 6] and the [developer 6] were prepared in the same manner as Example 1 except that the opening of the sieve in the classification process was changed to 26 μm.

### Comparative Example 3

In Example 1, the [toner 7] and the [developer 7] were prepared in the same manner as Example 1 except that the opening of the sieve in the classification process was changed to 25 μm and the opening of the sieve after external addition treatment was changed to 25 μm.

### Comparative Example 4

In Example 1, a wet sieve was not performed in the classification process, and the [toner 8] and the [developer 8] were prepared in the same manner as Example 1 except that the [toner base particle 1] was removed by air flow classification.

### Comparative Example 5

In Example 1, the [toner 9] and the [developer 9] were prepared in the same manner as Example 1, except that the maturing time was extended.

### Comparative Example 6

In Example 1, the amount of the [fine particle dispersion liquid 1] was increased, a wet sieve was performed as a classification process, and the [toner 10] and the [developer 10] were prepared in the same manner as Example 1 except that the [toner base particle 1] was removed by air flow classification.

### Measurement

### Black Spot

A BK solid images were printed using a color multifunction device (imagio MP C4500, manufactured by Ricoh) at 27° C. in the laboratory environment at 80%, and the primary transfer current were changed as needed to find the condition with the largest number of black locators. The number of black locators is used as the number of black locators.

### Evaluation Standards

Excellent: Almost no black spots are seen.
Good: Black spots can be seen in the image.
Fair: More than 50 black spots are seen in the image.
Poor: There are many black spots clearly. (100 or more)

### Cleaning Properties

A color multifunction device (imagio MP C4500, manufactured by Ricoh) was used to output 50,000 sheets (A4 size side) of an image area ratio 5% chart in 3 prints/jobs at a laboratory environment of 21° C. at 65% RH, and 50,000 sheets were passed through as follows.

Subsequently, at 32° C. in the laboratory environment at 54% RH, a vertical strip pattern (in the direction of paper travel) of 43 mm width and 100 sheets of three charts were output across the A4 size as evaluation images. The obtained images were visually observed, and the cleaning properties was evaluated according to the presence or absence of image abnormalities due to cleaning failure.

### Evaluation Standards

Excellent: The toner slipped out due to poor cleaning cannot be visually observed on the photoconductor or on the printed paper. Also, thread-like slippage of the toner cannot be observed when the photoconductor was viewed in the longitudinal direction with a microscope.
Good: Toner slipped out due to poor cleaning cannot be visually observed neither the printed paper nor the photoconductor.
Fair: Toner slipped out due to poor cleaning can be visually observed slightly on the photoconductor, but not on the printed paper.
Poor: Toner slipped out due to poor cleaning can be visually checked on both the printed paper and the photoconductor.

### Method of Measurement of Coarse Particles (1)

In this application, “number content of coarse particles of 20 μm or more” is determined by the following method.

Place a rag and a mesh with a 20 μm mesh opening on the hose (38 mm diameter) of a vacuum cleaner (blower) in this order. The vacuum cleaner should be pre-checked with an airflow meter to ensure that the airflow is at 8 to 12 m/s. Switch on the vacuum cleaner and put 10 mg of toner on the mesh in the center of the suction area. Let the vacuum cleaner suction the mesh 5 times in the X-axis direction and 5 times in the Y-axis direction, remove the mesh from the vacuum cleaner hose, and tap it lightly on the desk 5 times.

Then, the surface of the sieve is photographed with a microscope, and the number of all remaining toner particles (the large toner particles having a particle diameter of 20 μm or more) on the sieve in the captured image is counted. This is performed at room temperature (20° C.).

### Method of Measurement of Coarse Particles (2)

In this application, “number content of coarse particles of 25 μm or more” is determined by the following method.

Place a rag and a mesh with a 25 μm mesh opening on the hose (38 mm diameter) of a vacuum cleaner (blower) in this order. The vacuum cleaner should be pre-checked with an airflow meter to ensure that the airflow is at 8 to 12 m/s. Switch on the vacuum cleaner and put 2 g of toner on the mesh in the center of the suction area. Let the vacuum cleaner suction the mesh 5 times in the X-axis direction and 5 times in the Y-axis direction, remove the mesh from the vacuum cleaner hose, and tap it lightly on the desk 5 times.

Then, the surface of the sieve is photographed with a microscope, and the number of all remaining toner particles (the large toner particles having a particle diameter of 25 μm or more) on the sieve in the captured image is counted. This is performed at room temperature (20° C.).

Table 1 shows the evaluation results of the toner of the Examples and the Comparative Examples.

TABLE 1

| | | Example | | | | Comparative Example | | | | | |
|---|---|---|---|---|---|---|---|---|---|---|---|
| | | 1 | 2 | 3 | 4 | 1 | 2 | 3 | 4 | 5 | 6 |
| Toner No. | | 1 | 2 | 3 | 4 | 5 | 6 | 7 | 8 | 9 | 10 |
| Volume average particle | | 5.1 | 5.2 | 5.3 | 5.3 | 5.1 | 5.3 | 5.1 | 5.1 | 6.4 | 3.9 |
| diameter of resin | | | | | | | | | | | |
| Mesh of the | before external | 20 | 21 | 23 | 25 | 20 | 26 | 25 | air flow | 20 | air flow |
| sieve (μm) | addition treatment | | | | | | | | classifi- | | classifi- |
| | | | | | | | | | cation | | cation |
| | after external | 38 | 38 | 38 | 20 | 20 | 38 | 25 | 38 | 38 | 38 |
| | addition treatment | | | | | | | | | | |
| The number of the | 25 μm or more | 10 | 20 | 48 | 3 | 0 | 66 | 0 | 10 | 30 | 5 |
| coarce particles | 20 μm or more | 15 | 58 | 246 | 40 | 5 | 317 | 261 | 300 | 245 | 20 |

| | | | | | | | | | | |
|---|---|---|---|---|---|---|---|---|---|---|
| The number of balack spots | Excellent | Excellent | Good | Excellent | Excellent | Fair | Fair | Fair | Fair | Good |
| Cleaning properties | Excellent | Excellent | Good | Good | Fair | Excellent | Good | Good | Good | Fair |

As described above, in Examples 1 to 4, black spots and excellent cleaning performance were obtained.

Conversely, Comparative Example 1 had a cleaning failure as the number of coarse particles of 20 μm or more is 10 or less.

In Comparative Example 2, the number of black spots was increased because the number of coarse particles of 20 μm or more is 250 or more.

In Comparative Example 3, there were no coarse particles of 25 μm or more, but the number of black spots increased because there were 250 or more coarse particles of 20 μm or more.

In Comparative Example 4, in which the airflow classification was used, is disadvantageous because the coarse particles cannot be selectively removed with the airflow classification.

In Comparative Example 5, although the number of coarse particles of 20 μm or more was 250 or less, the volume average particle size exceeds 6.0 μm, resulting in increasing in the number of black group points.

In Comparative Example 6, although the number of coarse particles of 20 μm or more was 250 or less, the volume average particle size was too small, resulting in deteriorating of the cleaning property.

An aspect of the disclosure is as follows, for example.
(1) A toner containing at least a binder resin, a colorant, a wax, and an external additive, wherein the volume average particle size of the toner particles is between 4.0 μm and 6.0 μm,

A toner, wherein the number of coarse particles defined as follows in 10 mg of said toner is between 10 and 250.
(2) The toner according to claim 1), wherein the number of the coarse particles of 25 μm or more in the toner 2g is 25 or less.
(3) A developer comprising the toner according to (1) or (2) above.
(4) A toner receiving unit containing the toner described in (1) or (2) above.
(5) An electrostatic latent image carrier,

An electrostatic latent image forming unit that forms an electrostatic latent image on said electrostatic latent image carrier,

A developing means comprising toner for developing the electrostatic latent image formed on the electrostatic latent image carrier to form a toner image,

The image forming apparatus, wherein the toner is the toner according to the above-described (1) or (2).
(6) An electrostatic latent image forming step of forming an electrostatic latent image on the electrostatic latent image carrier,

A developing step of developing the electrostatic latent image formed on the electrostatic latent image carrier using toner to form a toner image.

The image forming method, wherein the toner is the toner according to the above-described (1) or (2).

What is claimed is:

1. Toner comprising toner particles that comprise,
a binder resin, and
wherein the toner particles have a volume average particle diameter from 4.0 μm to 6.0 μm, and
wherein the toner has a number content of coarse particle of 20 μm or more from 10 to 250 in 10 mg of the toner.

2. The toner according to claim 1, wherein the number of the coarse particles of 25 μm or more per 2 g of the toner is 25 or less.

3. A developer comprising the toner according to claims 1.

4. A toner storage container comprising the toner according to claim 1.

5. The image forming apparatus comprising:
an electrostatic latent image bearer;
an electrostatic latent image forming unit that forms an electrostatic latent image on the electrostatic latent image bearer;
a developing means comprising toner for developing the electrostatic latent image formed on the electrostatic latent image bearer to form a toner image;
wherein the toner is the toner according to claim 1.

6. The image forming method comprising:
an electrostatic latent image forming step to form an electrostatic latent image on the electrostatic latent image bearer,
a developing step to develop the electrostatic latent image formed on the electrostatic latent image bearer to form a toner image using toner,
wherein the toner is the toner according to claim 1.

7. The toner according to claim 1, wherein the toner particles comprise a colorant.

8. The toner according to claim 1. wherein the toner particles comprise a wax.
